(19) United States
(12) Patent Application Publication
(10) Pub. No.: US 2011/0034715 A1
(43) Pub. Date: Feb. 10, 2011

(54) Cyclopentadienylphosphazene complexes (CpPN Complexes) of metals of the third and fourth group and of the lanthanoids

(76) Inventors: Jörg Sundermeyer, Marburg (DE); Konstantin Rufanov, Moscow (RU); Alexander Petrov, Braunschweig (DE); Michael Elfferding, Marburg (DE); Manuel Winkenstette, Munchen (DE)

Correspondence Address: CLARK & BRODY, 1700 Diagonal Road, Suite 510, Alexandria, VA, 22314, US

(21) Appl. No.: 12/745,037

(22) PCT Filed: Nov. 25, 2008
(86) PCT No.: PCT/DE08/01942

§ 371 Date: Oct. 25, 2010

(30) Foreign Application Priority Data
Nov. 28, 2007 (DE) 10 2007 057 854.9

(51) Int. Cl. C07F 15/00

(52) U.S. Cl. 556/21

(57) ABSTRACT

The present invention concerns cyclopentadienylphosphazene complexes (CpPN complexes) of the metals of the third and fourth group and of the lanthanoids with the exception of lutetium. The complexes according to the present invention are isolobal and isoelectronic to [(CpSiN)TiR₂] complexes.

Exactly one CpPN unit is present in the complexes according to the present invention. In all complexes according to the present invention, the cyclopentadienyl unit of CpPN represents a monodentate, anionic ligand of the metal atom. Furthermore, the metal atom is bound to further anionic ligands. In a preferred embodiment, both the cyclopentadienyl unit and the nitrogen atom are bound within CpPN to the metal atom, so that CpPN then represents a bidentate ligand. Complexes according to the present invention, in which CpN represents a bidentate ligand, are CpPN-constrained geometry complexes (CpPN-CGC). Furthermore, methods are provided for the in situ production of the complexes according to the present invention.

The CpPN complexes can be electrically neutral or can be present as cationic complexes. Cationic complexes are formed by replacing one of the other anionic ligands of the metal atom by a neutral ligand; counterions of the cationic CpPN complexes are preferably fluoroborate, tetraphenyl borate, tetrakis-(3,5-trifluormethylphenyl)borate.

The production is carried out in situ by reacting a metal halide with a protonated cyclopentadienylphosphazene CpPNH and an alkaline or alkaline earth salt of the desired other anionic ligand.

The complexes according to the present invention are suitable for being used as catalysts for the hydroamination and polymerization of olefins.

The present invention concerns cyclopentadienylphosphazene complexes (CpPN complexes) of the metals of the third and fourth group and of the lanthanoids with the exception of lutetium. In these complexes, the cyclopentadienyl unit (CpPN) is bound as an anionic ligand to the metal atom, and the metal atom is moreover bound to further ligands which do not belong to the CpPN unit. The present invention also relates to methods for producing the CpPN complexes. The complexes according to the present invention are suitable for being used as catalysts for the hydroamination and polymerization of olefins.

### DESCRIPTION AND INTRODUCTION TO THE GENERAL FIELD OF THE INVENTION

The present invention concerns the fields of organometallic chemistry, coordination chemistry, rare-earth chemistry, chemistry of group III and IV of the Periodic Table, catalysis and polymer chemistry.

### STATE OF THE ART

The addition of amines RR′NH to olefins (hydroamination) takes place only via suitable catalysts. One of the greatest challenges is that of increasing of the catalyst efficiency, particularly in the intermolecular variant. The copolymerization of sterically demanding olefins also requires suitable catalysts.

Metallocene catalysts known to date provide unsatisfactory results in the hydroamination and also the copolymerization of olefins, since the activity, selectivity and breadth of application of the metallocenes is not very high. Such catalysts are described for example in EP 0 416 815 A2, in P J Shapiro, Organometallics 1990, 867-871 and J Okuda, Chem Ber 1990, 1649-871.

Cyclopentadienyl silylamide complexes of the early transition metals—the so-called “constrained geometry catalysts” have evolved to become one of the best tested classes of specially adapted organometallic compounds, since they are used industrially as so-called “single-site catalysts” for olefin polymerization. Single-site catalysts are molecular units of general structure LₙMR, in which L is an organic ligand, M represents the metal center of the active catalyst, and R stands for the polymer or the starting group.

Cyclopentadienyl silylamide constrained geometry catalysts of titanium [(CpSiN)TiR₂] are widely used in industry, in particular for the copolymerization of sterically demanding olefins. They have the disadvantages mentioned above.

The structure of the CpSiN ligands makes a large number of individual variations of the ligand conceivable. For instance, the nature of the ligand can be varied by varying the substituents on the cyclopentadienyl ring, the bridge unit or on the nitrogen. The ligands on the metal can also be varied. All these variations can of course also be combined.

Further variation possibilities are also apparent taking account of the isolobal relationship between CpSiN and other cyclopentadienyl compounds: It can easily be seen that the bridging silicon atom can be replaced for example by a carbon atom. The amide group can also be replaced by other donor ligands. A large number of these systems have already been synthesized.

Cyclopentadienylphosphazenes are produced by reacting a metallated cyclopentadienyl compound with a chlorodialkyl- or chlorodiarylphosphane, wherein a cyclopentadienylphosphane is obtained. The next synthesis step is a Staudinger reaction. If the desired alkyl-, aryl- or element-organic azide is added to the cyclopentadienylphosphane, the so-called Staudinger adduct is formed, which is stable at lower temperatures.

CpSiN complexes known so far and cyclopentadienyl compounds isolobal thereto are described for example in:
1. S. Feng, Organometallics 1999, 18, 1159-1167,
2. A. J. Ashe, Organometallics 1999, 18, 1363-1365,
3. J. Klosin, Organometallics 2001, 20, 2663-2665,
4. P. J. Sinnema, Organometallics 1997, 16, 4245-4247,
5. P. T. Gomes, J. Organomet. Chem. 1998, 551, 133-138,
6. L. Duda, Eur. J. Inorg. Chem. 1998, 1153-1162,
7. D. van Leusen, Organometallics 2000, 19, 4084-4089,
8. H. Braunschweig, Chem. Commun. 2000, 1049-1050,
9. K. Kunz, J. Am. Chem. Soc. 2001, 123, 6181-6182,
10. K. Kunz, Organometallics 2002, 21, 1031-1041,
11. V. Kotov, Eur. J. Inorg. Chem. 2002, 678-691,
12. F. Amor, Organometallics 1998, 17, 5836-5849,
13. J. Okuda, J. Organomet. Chem. 1999, 591, 127-137,
14. J. T. Park, Organometallics 2000, 19, 1269-1276,
15. J. Jin, Chem. Commun. 2002, 708-709,
16. Y. X. Chen, Organometallics 1997, 16, 5958-5963,
17. K. Kunz, J. Am. Chem. Soc. 2002, 124, 3316-3326,
18. T. lshiyama, Organometallics 2003, 22, 1096-1105,
19. L. E. Turner, Chem. Commun. 2003, 1034-1035,
20. W. A. Herrmann, Angew. Chem. Int. Ed. Engl. 1994, 33, 1946-1949,
21. J. Cano, Angew. Chem. Int. Ed. 2001, 40, 2495-2497,
22. J. Cano, Eur. J. Inorg. Chem. 2003, 2463-2474

The chelating cyclopentadienylphosphazenes (CpPNs) and cyclopentadienylanylidenes are isolobal to these cyclopentadienyl silylamide complexes. This is described for example in K A Rufanov, Eur J Org Chem 2205, 3805-3807 for a CpPN complex of lutetium. However, one disadvantage here is that lutetium is very rare and expensive and the production of the complex takes place via organometallic starting compounds. Organolanthanoid compounds are often unstable and, due to the resulting obstacles during synthesis, no corresponding CpPN complexes of other lanthanoids are known so far. Many of the previously known lanthanoid complexes comprise THF as the neutral ligand, as shown for example in H Schumann, J Organomet Chem 1993, 462, 155-161 and in W J Evans, Organometallics 1996, 15, 527-531. These complexes are often easily decomposable.

The present invention overcomes the disadvantages of the state of the art by providing for the first time cyclopentadienylphosphazene complexes (CpPN complexes) of the metals of the third and fourth group and of lanthanoids with the exception of lutetium, which [lacuna] as catalysts. The CpPN complexes according to the present invention are suitable for being produced in situ, wherein it is no longer required to make use of the partially unstable alkyl compounds of these metals. Instead, a new in-situ method according to the present invention for the production thereof is presented, in which the easily obtainable and stable metal halides can be used as starting materials.

The complexes according to the present invention are isolobal and isoelectronic to [(CpSiN)TiR₂] complexes. They are stable for a long time under an inert atmosphere at room temperature are suitable catalysts for the hydroamination and polymerization of olefins.

### Aim

The aim of the present invention is therefore to provide cyclopentadienylphosphazene complexes (CpPN complexes) of metals of the third and fourth group and also of lanthanoids with the exception of lutetium, and methods for the production thereof.

### Achievement of this Aim

This aim is achieved according to the present invention through cyclopentadienylphosphazene complexes (CpPN complexes) of metals of the third and fourth group and of lanthanoids, in which
the metal is selected from the group Sc, Y, La, Ti, Zr, Hf, Ce, Pr, Nd, Pm,

Sm, Eu, Gd, Tb, Dy, Ho, Er, Tm, Yb, in which the metal atom
is in the oxidation state +III, if it is a metal of the third group or a lanthanoid, or
is in oxidation stage +IV if it is a metal of the fourth group, and
exactly one cyclopentadienylphosphazene unit is present in the complex, and
the cyclopentadienylphosphazene unit is bound as a monoanionic ligand to the metal atom and
the metal atom is also bound to further anionic ligands which do not belong to the cyclopentadienylphosphazene unit.

Surprisingly, it has been found that metals of the third and fourth group and also lanthanoids form complexes with cyclopentadienylphosphazene ligands. In these complexes, the cyclopentadienyl unit within the cyclopentadienylphosphazene represents a monoanionic ligand of the metal atom.

Hereinafter, the complexes according to the present invention will be referred to as CpPN complexes.

In a preferred embodiment of the present invention the cyclopentadienylphosphazene unit (CpPN) of the complexes according to the present invention represents a bidentate ligand. In this case, the bonding of the cyclopentadienylphosphazene unit to the metal atom takes place both via the monoanionic cyclopentadienyl unit of the CpPN and also via the nitrogen atom. Cyclopentadienylphosphazene complexes according to the present invention, in which the cyclopentadienylphosphazene unit acts in this way as a bidentate ligand, are referred to as cyclopentadienylphosphazene constrained geometry complexes or—without explicit indication of the hapticity of the ligand—as cyclopentadienylphosphazene constrained geometry complexes. Hereinafter, these complexes are also referred to as CpPN—CGC.

According to these definitions, CpPN-CGCs are always also CpPN complexes.

The term “Constrained Geometry Complex” was originally used in the state of the art for those organometallic complexes in which a pi-ligand (for example a cyclopentadienyl residue) is bound to one of the other ligands on the same metal center in such a way that the bite angle is smaller than a corresponding ligand-metal-ligand angle in comparable unbridged complexes. The term “bite angle” denotes a ligand-metal-ligand angle which is formed when a bidentate or polydentate ligand coordinates to a metal center.

In particular, this term was originally used for ansa-bridged cyclopentadienyl silylamide complexes. The term “Constrained Geometry Complex” (CGC) is meanwhile used for a larger group of complexes and encompasses chelating, donor-functionalized cyclopentadienyl half-sandwich complexes, some of which are isolobal and/or isoelectronic to the ansa-bridged cyclopentadienyl silylamide complexes. This broadened definition of constrained geometry complexes covers for example cyclopentadienylphosphazene complexes and cyclopentadienyiphosphoranylidene complexes, which are both likewise chelating. According to this broadened definition which has now become customary, the constrained geometry complexes also include those cyclopentadienylphosphazene complexes according to the present invention in which both the monoanionic cyclopentadienyl group and the nitrogen atom of the cyclopentadienylphosphazene act as ligands for the metal atom.

The term “isolobal” refers to the similarity of the frontier orbitals of two molecule fragments. Two molecule fragments are “isolobal” if the number, symmetry properties, energy and configuration of their frontier orbitals are similar.

By contrast, two atoms, ions or molecules are “isoelectronic” if they have the same number of electrons, even though they consist of different elements.

Cyclopentadienylphosphazenes in the context of the present invention are structures of the general formula (Ia)

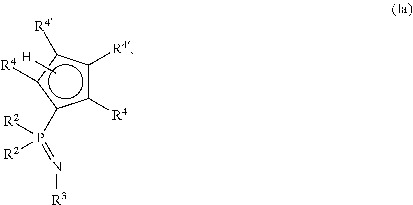

wherein
R²=a branched or unbranched alkyl group with 1 to 10 carbon atoms, or an aryl group,
R³=a branched or unbranched alkyl group with 1 to 10 carbon atoms, or an aryl group, and
R⁴ and R^{4′}═H or methyl (Me) or
R⁴, R^{4′}, and the cyclopentadienyl ring together form a 4,4,6,6-tetramethyl-5,6-dihydropentalene-2(4H)-ylidene unit.

Optionally, three of the residues R⁴ and R^{4′} may be hydrogen, and a substituent R^{4″} is bound to the fourth carbon atom of the cyclopentadienyl ring according to formula (Ib):

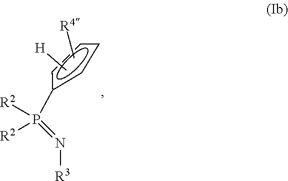

wherein R² and R³ have the meanings indicated above and R^{4″} is selected from tert-butyl or —SiMe₃.

If R² and/or R³ are branched or unbranched alkyl groups having 1 to 10 C atoms, these are preferably selected from methyl, ethyl, n-propyl, 2-propyl, n-butyl, 2-butyl, tert-butyl.

In a preferred embodiment

R² is selected from methyl (Me) and phenyl (Ph) and

R³ is selected from 1-adamantyl, 2,6-diisopropylphenyl, phenyl, tert-butyl and 2,4,6-trimethylphenyl (mesityl).

The monoanionic form of the cyclopentadienylphosphazene (CpPN) is formally formed by abstracting a proton. The monoanionic CpPN ligand of the complexes according to the present invention thus has the general form (Ic)

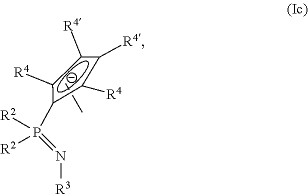

wherein R², R³, R⁴ and R^{4′} have the meanings indicated above. Structures according to formula (Ib) can be deprotonated in an analogous manner.

Preference is given to those monoanionic cyclopentadienylphosphazenes in which

R²=methyl (Me) or phenyl (Ph),

R³=1-adamantyl (Ad) or 2,6-diisopropylphenyl (Dip) and

R⁴ and R^{4′}═H or methyl (Me) or

R⁴, R^{4′}, and the cyclopentadienyl ring together form a 4,4,6,6-tetramethyl-5,6-dihydropentalene-2(4H)-ylidene unit.

The structures of these preferred monoanionic cyclopentadienylphosphazenes are shown below:

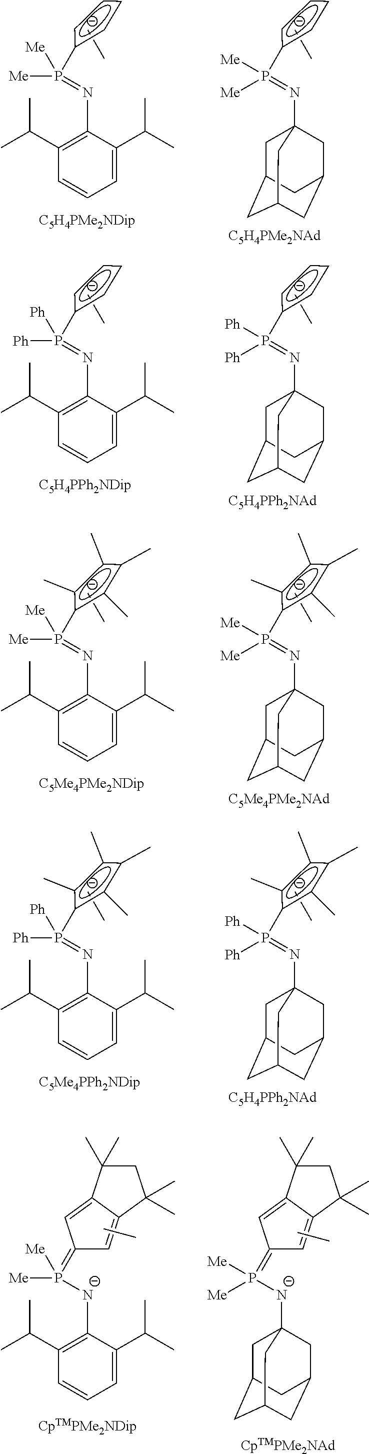

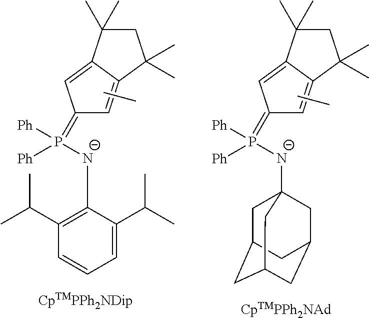

In these formula stand

Me for a methyl group, Ph for a phenyl group,

Ad for a 1-adamantyl group, Dip is a 2,6-diisopropylphenyl group and

Cp™ for a 4,4,6,6-tetramethyl-5,6-dihydropentalene-2(4H)-ylidene group.

In uncomplexed cyclopentadienylphosphazenes, the P-amino-cyclopentadienylidenephosphorane form according to formula (Ia) is in tautomeric equilibrium with the corresponding P-cyclopentadienyliminophosphorane structure. This is shown in (II):

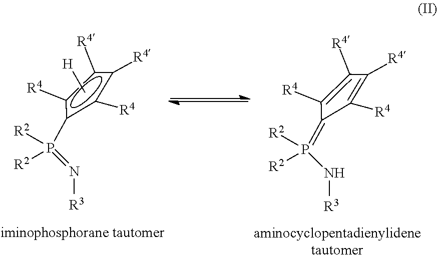

According to the invention, metals of the third group are selected from Sc, Y and La and metals of the forth group are selected from Ti, Zr and Hf. Lanthanum (La) is on the one hand a metal of the third group. On the other hand, however, it is also the first representative of the group of the 4f element group named after it, namely the lanthanoids. In the frame of the present invention, La is assigned to the third group, and the “lanthanoids”, which represent the central atoms of the complexes according to the present invention, are understood to be the metals Ce, Pr, Nd, Pm, Sm, Eu, Gd, Tb, Dy, Ho, Er, Tm and Yb.

In this case, the metal atom is in oxidation stage +III if it is a metal of the third group or a lanthanoid, and is in oxidation stage +IV if it is a metal of the fourth group.

According to the present invention, the metal atom in the CpPN complexes according to the present invention is bound not only to a cyclopentadienylphosphazene unit but also to other ligands. The complex fragment according to the present invention consisting of the metal atom and other ligands is formally a cationic fragment according to formula (III)

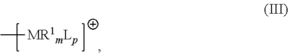

wherein M, R¹, L, m and p have the following meanings:
M=a metal selected from the group Sc, Y, La, Ti, Zr, Hf, Ce, Pr, Nd, Pm, Sm, Eu, Gd, Tb, Dy, Ho, Er, Tm, Yb,
m=3 if the metal is of the fourth group and thus is in oxidation stage +IV,
m=2 if the metal is of the third group or a lanthanoid and thus is in oxidation stage +III,
p=0 or 1,

and

R¹ are anionic ligands which independently of one another are selected from
fluoride, chloride, bromide, iodide, cyanide, cyanate, thiocyanate, azide,
-Me, —CH₂, CH₂CMe₂Ph, —CH₂CMe₃, —CH₂Ph, —CH₂SiMe₃,
—O-Aryl, OSiMe₃,
—OR⁵, —NR⁵₂,
wherein
   R⁵=a branched or unbranched alkyl group with 1 to 10 carbon atoms, or a phenyl group,
and
L represents a neutral ligand, selected from
   an ether (for example THF, diethyl ether Et₂O, dimethoxyethane DME), a thioether, a tertiary amine, pyridine.

If R⁵ is a branched or unbranched alkyl group having 1 to 10 C atoms, this is preferably selected from methyl, ethyl, n-propyl, 2-propyl, n-butyl, 2-butyl, tert-butyl.

Since in the complexes CpPN according to the present invention the cyclopentadienyl unit (within the cyclopentadienylphosphazene) is a monoanionic ligand of the metal atom, then, by combining this monoanionic ligand with the formally cationic fragment according to formula (III), neutral complexes of general formula (IV) are obtained

[(CpPN)MR¹ₘ(L)ₚ] (IV),
wherein
m, p, R¹ and L are as defined above.

If R¹ represents a group —NR⁵₂ according to the above definition, then in the corresponding CpPN complex the cyclopentadienyl unit represents a monoanionic and monodentate ligand of the metal atom, while the nitrogen atom of the cyclopentadienylphosphazene unit does not coordinate to the metal atom. These CpPN complexes are represented by the general formula (V)

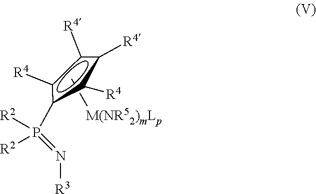

wherein m, p, R², R³, R⁴, R^{4′} and R⁵ and L have the meanings indicated above.

If R1 represents a group according to the definition given above with the exception of —NR⁵₂, then in the corresponding CpPN complex the cyclopentadienylphosphazene unit (CpPN) of the complexes according to the present invention represents a bidentate ligand. In this case, the bonding of the cyclopentadienylphosphazene unit to the metal atom takes place both via the monoanionic cyclopentadienyl unit of the CpPN and also via the nitrogen atom. These CpPN-CGC complexes are represented by the general formula (VI)

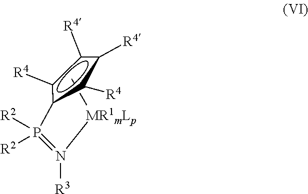

wherein m, p, R², R³, R⁴, R^{4′} and R⁵ and L have the meanings indicated above.

In a further embodiment of the present invention, R¹ according to the according to the definition above is a halide X selected from fluoride, chloride, bromide, iodide. Formula (VII) shows the anhydrous CpPN complexes of this embodiment:

[(CpPN)MXₘ(thf)ₜ] (VII)

In this formula, M and m are as defined above, and
t=0, 1, 2 or 3 for a metal of the third group or a lanthanoid,
t=0, 1, 2 for a metal of the fourth group.

In a further embodiment of the present invention, an anionic ligand R¹ in the CpPN complex of formula III according to the present invention is replaced by at least one neutral ligand L.

Particular preference is given in this case to those CpPN complexes according to the present invention in which an anionic ligand R¹ according to formula III is replaced by a neutral ligand L, resulting in cationic CpPN complexes with an anion X⁻ according to formula (VIII)

[(CpPN)MR6ₘ₋₁(L)]^{⊕}X^{⊖} (VIII),
wherein
   M=metal, selected from the group Sc, Y, La, Ti, Zr, Hf, Ce, Pr, Nd, Pm, Sm, Eu, Gd, Tb, Dy, Ho, Er, Tm, Yb,
   CpPN=cyclopentadienylphosphazene,
   m=3 if the metal is of the fourth group and thus is in oxidation stage +IV,
   m=2 if the metal is of the third group or a lanthanoid and thus is in oxidation stage +III,
R⁶ represent anionic ligands which independently of one another are selected from
   fluoride, chloride, bromide, iodide, cyanide, cyanate, thiocyanate, azide,
   -Me, —CH₂, CH₂CMe₂Ph, —CH₂CMe₃, —CH₂Ph, —CH₂SiMe₃,
   —O-Aryl, —OSiMe₃,
   —OR⁵, —NR⁵₂,
   wherein
      R⁵=a branched or unbranched alkyl group with 1 to 10 carbon atoms, or a phenyl group,
and
L represents a neutral ligand, selected from
   an ether (for example THF, diethyl ether Et₂O, dimethoxyethane DME), a thioether, a tertiary amine, pyridine.
and
   X⁻ is selected from fluoroborate, tetraphenylborate, tetrakis-(3,5-trifluoromethylphenyl)borate.

In the frame of the present invention, preference is given to those CpPN complexes according to formulae (IV), (V), (VI), (VII) and (VIII) in which the metal atom is homoleptically coordinated in relation to those anionic ligands which do not represent a cyclopentadienylphosphazene unit.

Very particularly preferred are CpPN complexes of formulae (IV), (V), (VI), (VII) and (VIII) according to the present invention in which the metal atom is homoleptically coordinated by ligands in relation to those anionic ligands which do not represent a cyclopentadienylphosphazene unit, these anionic ligands being selected from the group —CH₂Ph, —CH₂SiMe₃ and NMe₂.

The aim of providing the CpPN complexes according to the present invention is achieved according to the invention by an in-situ method comprising the steps
reacting one equivalent of a metal halide MX_{q} with q equivalents of an alkali metal or alkaline earth metal salt of the ligand R¹ in an ether at a temperature below −70° C., wherein
   X=F, Cl, Br, I and
   q=3 if M is a metal of the third group or a lanthanoid,
   q=4 if M is metal of the fourth group,
   and R¹ is as defined above,
subsequently, one equivalent of a protonated cyclopentadienylphosphazene [CpPN]H is added.

Surprisingly, it has been found that the complexes of formula (IV) according to the present invention can be produced in situ by reacting one equivalent of a metal halide MX_{q} firstly with q equivalents of an alkali metal or alkaline earth metal salt of the ligand R¹ (with the exception of the halides and pseudohalides) and subsequently with one equivalent of the protonated cyclopentadienylphosphazene [CpPN]H.

The metal halide MX_{q} is in this case a fluoride, chloride, bromide or iodide of a metal of the third or fourth group or of a lanthanoid, selected from Sc, Y, La, Ti, Zr, Hf, Ce, Pr, Nd, Pm, Sm, Eu, Gd, Tb, Dy, Ho, Er, Tm, Yb. The alkali metal or alkaline earth metal salt of the ligand R¹ is the corresponding lithium, sodium, potassium or magnesium salt.

Suitable ethers are for example diethyl ether, dimethyl ether, dimethoxyethane (DME) and tetrahydrofurane (THF).

The in-situ reaction is shown by way of example for a Li salt of the ligand R¹ and THF as solvent:

MX_{q}(thf)ₓ+q R¹—Li=[MR¹_{q}]*q LiX*y(thf)ₓ] (associate) [MR¹_{q}]*q LiX*y(thf)ₓ]+[CpPN]H=[(CpPN)M(R¹_{q-1})(thf)_{y}]+q Li—X+R¹—H

The Li salt of the ligand R¹ is mentioned here by way of example.

R¹ and q are as defined above.

THF molecules are bound in the metal halide and in the associate.

x=2 for q=4 and

x=3 for q=3

y, i.e. the number of associated THF molecules, is an integer between 0 and 3 for metals of the third group and lanthanoids and is an integer between 0 and 2 for metals of the fourth group.

Alternatively, the in-situ production of the CpPN complexes of formula (IV) according to the present invention can also take place by first reacting one equivalent of the metal halide MX_{q} with one equivalent of the protonated ligand [CpPN]H and then adding q equivalents of an alkali metal or alkaline earth metal salt of the ligand R¹, wherein this in-situ reaction is carried out as described above in an ether as solvent and at temperatures below −70° C.

This alternative in-situ reaction is shown by way of example for a Li salt of the ligand R¹ and THF as solvent:

MX_{q}(thf)ₓ+[CpPN]H=[(CpPN—H)MX_{q}(thf)_{y}] [(CpPN—H)MX_{q}(thf)_{y}]+q R¹—Li=[(CpPN)M(R¹_{q-1})(thf)_{y}]+q Li—X+R¹—H

Here q, x, y and R¹ are as defined above.

In a further embodiment, the production of the CpPN complexes of formula (IV) according to the present invention takes place by reacting one equivalent of an isolated compound MR⁷_{q} with one equivalent of the protonated ligand [CpPN]H in an ether, in an aliphatic tertiary amine, in hexane or in toluene at temperatures below −70° C.

Here R⁷ is selected from
-Me, —CH₂, CH₂CMe₂Ph, —CH₂CMe₃, —CH₂Ph, —CH₂SiMe₃,
—O-Aryl, —OSiMe₃,
—OR⁵, —NR⁵₂,
wherein
   R⁵=a branched or unbranched alkyl group with 1 to 10 carbon atoms, or a phenyl group, and
q is as defined above.

In this case, the compound MR⁷_{q} may exist in the form of its etherate or its complex with an aliphatic tertiary amine.

The ether is selected from THF, diethyl ether, dimethyl ether, DME. If instead an aliphatic tertiary amine is used as solvent, then this is selected for example from N,N,N,N-tetramethylethylenediamine, TMEDA or N-methylpyrrolidine.

This production method is formally represented by the following reaction equation:

M(R⁷)_{q}(ether, amine)ₓ+[CpPN]H=[(CpPN)M(R⁷)_{q-1}]+R⁷—H+ether, amine

Here, x, q and R⁷ have the meanings indicated above.

Complexes of formula VII according to the present invention

[(CpPN)MXₘ(thf)ₜ] (VII)

are produced by reacting one equivalent of the anhydrous metal halide in an ether at a temperature below −70° C. with an alkali metal or alkaline earth metal salt of the CpPN ligand.

Hereby, the ether is selected from THF, diethyl ether, dimethyl ether, DME (dimethoxyethane). The alkali metal or alkaline earth metal salt is preferably a lithium, sodium, potassium or magnesium salt.

Cationic CpPN complexes of formula VIII according to the present invention

[(CpPN)MR⁶ₘ₋₁(L)]^{⊕}X^{⊖} (VIII)

are produced by reacting the corresponding complex [(CpPN)MR⁶ₘ] with a cation-generating reagent.

To produce the cationic species, the following cation-generating reagents are used (L is a weakly coordinating solvent molecule), m=2 for a trivalent rare earth metal, m=3 for a quadrivalent group 4 metal:
1. Halogen and pseudohalogen complexes (R⁶=halogen, pseudohalogen) are reacted with methylaluminoxane ([MeAlO]_{z}):

[(CpPN)M(R⁶)ₘ]+[MeAlO]_{z}+L=[(CpPN)M(R⁶)ₘ₋₁L]⁺+[R⁶-MeAlO]⁻
2. Alkyl complexes are reacted with tris(pentafluorophenyl)borane B(C₆F₅)₃(BCF):

[(CpPN)M(R⁶)ₘ]+BCF+L=[(CpPN)M(R⁶)m₋₁L]⁺+[R⁶—BCF]⁻
3. Alkyl complexes are reacted with oxonium tetraarylborates: BARF⁻=[B{3,5-(CF₃)₂C₆H₃}₄⁻]

[(CpPN)M(R⁶)ₘ]+[H(OR₂)₂]BARF+L=[(CpPN)M(R⁶)ₘ₋₁L]⁺+[BARF]⁻R⁶—H
4. Alkyl complexes are reacted with tert-ammonium tetraarylborates:

[(CpPN)M(R⁶)ₘ]+[PhNMe₂H][B(C₆F₅)₄]+L=[(CpPN)M(R⁶)ₘ₋₁L]⁺+[B(C₆F₅)₄]⁻+R⁶—H+PhNMe₂
5. Alkyl complexes are reacted with tritylium tetraarylborates:

[(CpPN)M(R⁶)ₘ]+Ph₃C[B(C₆F₅)₄]+L=[(CpPN)M(R⁶)ₘ₋₁L]⁺+[B(C₆F₅)₄]⁻+Ph₃C—R⁶

Here, m is as defined above.

During this replacement of an anionic ligand R⁶ with a neutral ligand L, neither the oxidation stage nor the coordination number of the metal atom change.

The CpPN complexes according to the invention are surprisingly stable. Under an inert atmosphere, they can be stored at RT for at least 6 months.

The neutral CpPN complexes according to the present invention are suitable for being used as catalysts for the intramolecular hydroamination of aminoalkenes. In this case, the catalyst is preferably used in a quantity of 4-6 mol % relative to the aminoalkene.

The cationic CpPN complexes according to the present invention are suitable for being used as catalysts for the polymerization of olefins. For this purpose, the CpPN complex according to the present invention is used in the presence of a scavenger and a co-catalyst. One suitable scavenger is for example triisobutylaluminum (TIBA); suitable co-catalysts are methylaluminoxane (MAO) and tris(pentafluorophenyl)borane (BCF).

### EMBODIMENTS

### Embodiment 1

### Synthesis of 2,6-diisopropylphenylazide

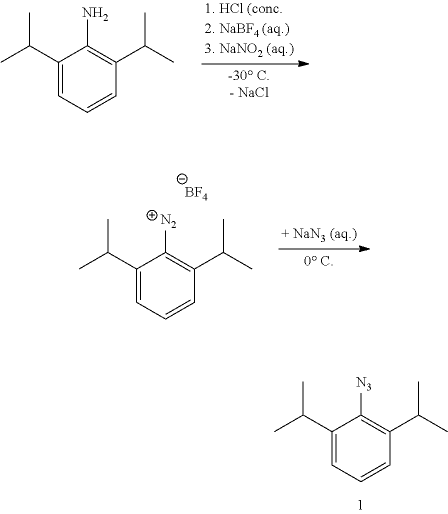

15.00 g (84.7 mmol) 2,6-diisopropylphenylamine was added dropwise at −30° C. to 60 mL concentrated hydrochloric acid. A white suspension was formed. To this suspension, a solution of 18.60 g (169.4 mmol) NaBF₄ in 30 mL distilled water was added dropwise. Subsequently, a solution of 6.44 g (93.5 mmol) NaNO₂ in 20 mL distilled water was added dropwise to this mixture. The suspension turned orange-yellow under the formation of brown vapors. The mixture was stirred for another 35 min at −30° C. and subsequently 70 mL ice water was added and the mixture was warmed to RT. After approximately 10 to 15 min at RT, an orange-colored liquid was formed under a yellow foam. The liquid was drawn off and discarded. Another 70 mL distilled water was added and the orange liquid was drawn from the bottom of the beaker. Using a spatula, the remaining yellow foam was added to a solution of 16.50 g (253.8 mmol) NaN₃ that had been cooled to 0° C. The mixture was warmed to RT and stirred for 1.5 h at RT until the incipient gas formation had ended. An orange oily substance was formed in a yellow aqueous solution. The aqueous phase was extracted three times, with 50 mL pentane each. The combined organic phases were dried over MgSO₄ and the obtained orange-colored solution was stirred for 12 to 16 hours over silica gel (Merck 60). The silica gel was filtered off and the solvent was removed under vacuum at RT. The yellow oil obtained was filtered over silica gel and eluted with 200 mL pentane. The solvent was again removed under vacuum and the yellow oil was dried under high vacuum.

Yield: 9.24 g (54%)

¹H-NMR (300.1 MHz, CDCl₃): δ=1.13 (d, ³J_{HH}=6.8 Hz, 12H, Me₂CH—), 3.32 (sept, ³J_{HH}=6.8 Hz, 2H, Me₂CH—), 7.04-6.93 (m, 3H, C₆H₃) ppm.

¹³C-NMR (75.5 MHz, CDCl₃): δ=24.0 (s, (CH₃)₂CH—), 28.5 (s, (CH₃)₂CH—), 124.2 (s, Cₒᵣₜₕₒ), 127.7 (s, Cₚₐᵣₐ), 137.3 (s, Cₘₑₜₐ), 143.1 (s, Cᵢₚₛₒ) ppm.

### Embodiment 2

### Synthesis of P-2,6-diisopropylamino-P-diphenyl-cyclopentadienylidenephosphorane via cyclopentadienylthallium

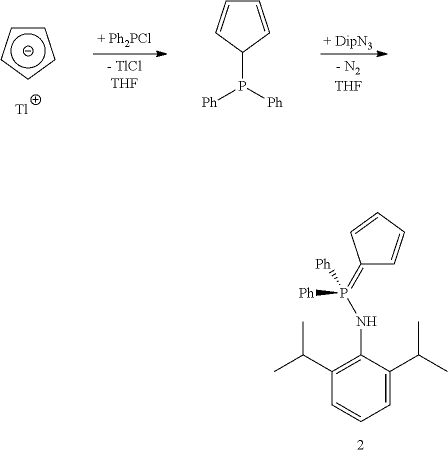

To a suspension of 2.03 g (7.58 mmol) TICp in 25 mL THF, a solution of 1.61 g (7.29 mmol) Ph₂PCl was added dropwise at RT. A white suspension in a green-yellowish liquid was formed immediately. The mixture was stirred for 1.5 h and subsequently filtered. The obtained yellow solution was cooled to 0° C. and 1.71 g (8.44 mmol) 2,6-diisopropylphenylazide was added. The solution was stirred at RT for 12 to 16 hours and subsequently heated to 50° C. for 1 h until gas formation was no longer recognizable. The solvent was subsequently removed, the obtained orange solid was suspended in a mixture of hexane/diethyl ether (1:1), filtered, washed with the same solvent mixture, and the bright yellow solid was dried under high vacuum.

Yield: 2.68 g (83%)

CHN: C₂₉H₃₂NP FW 425.55 g/mol

¹H-NMR (300.1 MHz, C₆D₆): δ=0.81 (d, 12H, ³J_{HH}=6.8 Hz, Me₂CH—), 3.24 (sept, 2H, ³J_{HH}=6.8 Hz, Me₂CH), 4.52 (d, ²J_{HP}=6.2 Hz, 1H, N—H), 6.36 (s, 2H, H-Cp). 6.50 (d, ^{3,4}J_{HP}=5.3 Hz, 2H, H-Cp), 7.01-6.99 (m, 1H, Ar), 7.26-7.18 (m, 2H, Ar), 7.57-7.37 (m, 10H, Ph) ppm.

¹³C-NMR (75.5 MHz, C₆D₆): δ=23.0 (Me₂CH—), 28.6 (Me₂CH—), 83.2 (d, ¹ J_{CP}=132.0 Hz, ipso-C_{Cp}), 114.5 (d, ^{2,3}J_{CP}=18.9 Hz, C_{Cp}), 116.9 (d, ^{2,3}J_{CP}=17.4 Hz, C_{Cp}), 123.9 (s, Ar), 126.8 (s, Arᵢₚₛₒ), 128.2 (d, J_{CP}=12.4 Hz, Ph), 128.3 (Ar), 131.7 (d, J_{CP}=5.9 Hz, Ph), 132.5 (d, J_{CP}=2.9 Hz, Ph), 133.5 (d, J_{CP}=10.9 Hz, Ph), 148.4(d, J_{CP}=2.5 Hz, Ar) ppm.

³¹P-NMR (121.5 MHz, C₆D₆): δ=40.7 ppm.

### Embodiment 3

### Synthesis of P-2,6-diisopropylamino-P-diphenyl-cyclopentadienylidenephosphorane via cyclopentadienylthallium

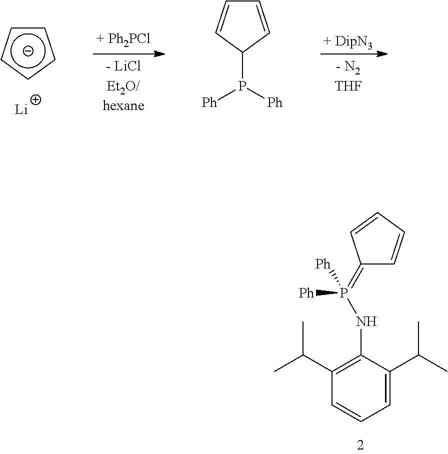

1.07 g (14.7 mmol) LiCp was suspended in a mixture of 60 mL diethyl ether and 60 mL hexane. A solution of 3.60 g (15.5 mmol) Ph₂PCl was added dropwise to the suspension, which had been cooled to 0° C. The color of the suspension changed immediately from white to bright yellow. The mixture was warmed to RT and stirred for 12 to 16 hours. The solution was filtered, the solvent was removed and the yellow liquid was dissolved in 10 mL THF. A solution of DipN₃ in 10 mL THF was added to the solution of CpPPh₂. The color changed immediately from yellow to dark red. In addition, gas formation and warming of the solution could be observed. The solution was stirred for 1 h at RT until gas formation was no longer recognizable. Subsequently, the solution was heated for 1 h to 65° C. A color change to brown could be observed. The solvent was drawn off and replaced by 50 mL hexane. Filtration and subsequent multiple washing with diethyl ether yielded a bright green powder, which was dried under high vacuum.

Yield: 1.464 g (23%)

¹H-NMR (300.1 MHz, C₆D₆): δ=0.79 (d, 12H, ³J_{HH}=7.0 Hz, Me₂CH—), 3.35 (sept, 2H, ³J_{HH}=6.8 Hz, Me₂CH), 4.64 (br, s, 1H, N—H), 6.82 (d, ^{3,4}J_{HP}=6.4 Hz, 2H, H-Cp), 6.87 (d, ^{3,4}J_{HP}=9.8 Hz, 2H, H-Cp), 7.08-6.98 (m, 8H, Ar, Ph), 7.40-7.34 (m, 6H, Ph) ppm.

³¹P-NMR (121.5 MHz, C₆D₆): δ=40.7 ppm.

### Embodiment 4

### Synthesis of P-1-1-adamantylamino-P-dimethyl-2,3,4,5-tetramethylcyclopentadienylidene-phosphorane

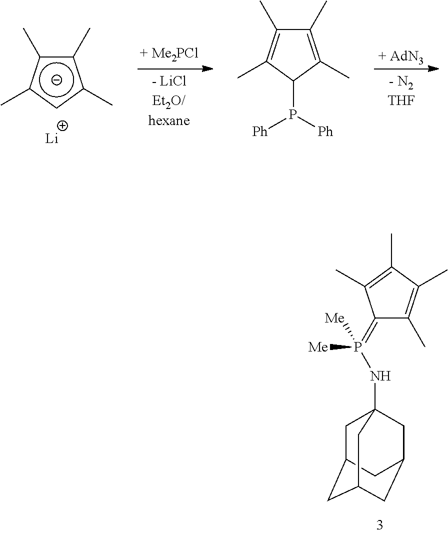

1.90 g (14.7 mmol) [LiC₅Me₄H] was suspended in a mixture of 60 mL hexane and 60 mL diethyl ether under stirring for one hour. The suspension was cooled to 0° C. and a solution of 1.50 g (15.5 mmol) Me₂PCl in 10 mL diethyl ether was added dropwise over approximately 20 min. The color of the suspension changed immediately from yellow to white. The mixture was warmed to RT and stirred during 12 to 16 hours. After filtration of the mixture, the solvent was removed via vacuum and the obtained yellow oil (2.87 g) was dissolved in 10 mL THF. Subsequently, a solution of 2.90 g (16.3 mmol) AdN₃ in 10 mL THF was added dropwise to the C₅Me₄HPMe₂ solution. After a short time, gas formation and a color change from yellow to orange was observed. The solution was stirred for 12 to 16 hours at RT and subsequently heated for 1 h to 50° C. until gas formation was no longer recognizable. The solvent was subsequently removed and the obtained orange-colored solid was suspended in 20 mL hexane. Filtration followed by washing three times with 10 mL hexane each yielded a white powder, which was dried under high vacuum.

Yield: 3.56 g (78%)

CHN: C₂₁H₃₄NP FW 331.48 g/mol

¹H-NMR (300.1 MHz, C₆D₆): δ=1.24 (d, ²J_{HP}=13.0 Hz, 6H, Me₂P; 1H, NH-Ad), 1.33-1.31 (br, m, 6H, CH—CH₂—CH), 1.40 (br, d, ⁴J_{HP}=2.7 Hz, 6H, N—C(CH₂)₃), 1.72 (br, s, 3H, CH_{Ad}), 2.48 (s, 6H, C₅Me₄), 2.50 (s, 6H, C₅Me₄) ppm.

¹³C-NMR (75.5 MHz, C₆D₆): δ=1.2 (s, C₅Me₄), 4.2 (s, C₅Me₄), 10.3 (d, ¹J_{CP}=67.7 Hz, Me₂P), 26.2 (s, CH_{Ad}), 35.8 (d, ⁴J_{CP}=3.3 Hz, CH—CH₂—CH), 43.1 (d, ³J_{CP}=6.1 Hz, N—C(CH₂)₃), 67.6 (s, P—NH—C_{Ad}), 70.1 (d, ¹J_{CP}=126.5 Hz, ipso-C_{Cp}), 107.9 (d, ^{2,3}J_{CP}=16.5 Hz, C(Me)═C(Me)), 109.8 (d, ^{2,3}J_{CP}=18.2 Hz, C(Me)═C(Me)) ppm.

³¹P-NMR (121.5 MHz, C₆D₆): δ=35.8 ppm.

### Embodiment 5

### Synthesis of [(η⁵:η¹-C₅H₄PPh₂NDip)ZrCl₃·thf]

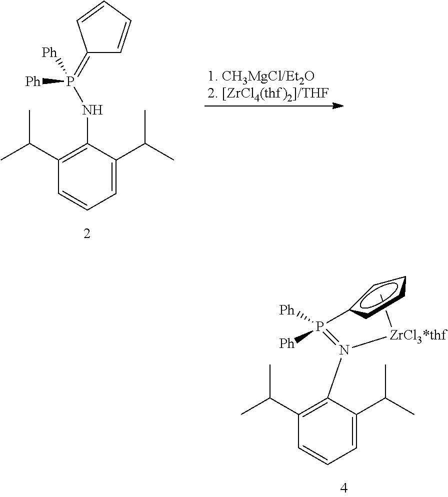

213 mg (0.5 mmol) C₅H₄PPh₂NHDip was dissolved in 10 mL THF, the solution was cooled to −78° C. and 0.17 mL (0.5 mmol) of a solution of methyl magnesium chloride in ether (3 M) was slowly added dropwise. The solution was stirred for 30 min each at −78° C., −45° C., 0° C. and at RT. The solution was subsequently heated briefly to boiling, until gas formation was no longer recognizable. The solution was cooled again to −78° C. and added dropwise to a cold solution (−78° C.) of 189 mg (0.5 mmol) [ZrCl₄(thf)₂] in 20 mL THF. A white precipitate was formed. The mixture was slowly warmed to RT and stirred for 12 to 16 hours at RT. The solvent was removed and the solid was taken up in 20 mL toluene. The orange colored solution was separated from the bright precipitate by filtration. The solvent was removed and the orange-yellow solid was dried under high vacuum. It is soluble in toluene and THF and insoluble in pentane and hexane.

³¹P-NMR (121.5 MHz, C₆D₆): 3 signals, main signal at δ=26.1 ppm.

### Embodiment 6

### Synthesis of [(η⁵:η¹-C₅Me₄PMe₂NAd)ZrCl₃·thf]

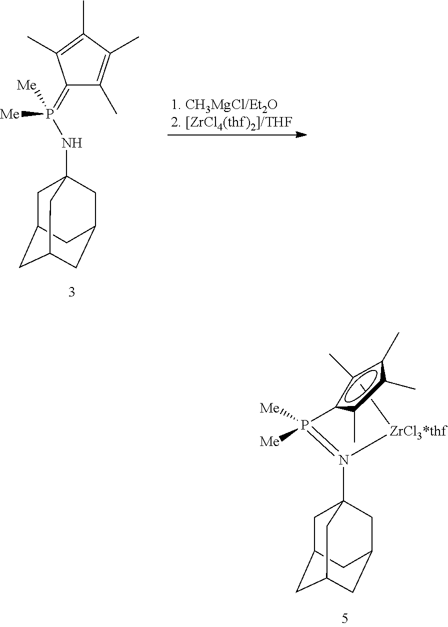

To a solution of 185 mg (0.5 mmol) C₅Me₄PMe₂NHAd in 10 mL THF, 0.17 mL (0.5 mmol) of a solution of methylmagnesium chloride in diethyl ether (3 M) was added dropwise at a temperature of 0° C. This was immediately accompanied by a strong gas formation. The solution was subsequently heated briefly to boiling, until gas formation was no longer recognizable. The solution was subsequently cooled to −78° C. and added dropwise to a solution of 189 mg (0.5 mmol) [ZrCl₄(thf)₂] in 10 mL THF which had been cooled to −78° C. as well. The solution was warmed to RT during 12 to 16 hours, the solvent was replaced by 15 mL toluene and filtered. After removal of the solvent under vacuum, a pale orange-colored solid was obtained. This solid is very difficult to dissolve in C₆D₆, insoluble in hexane and pentane and soluble in THF.

³¹P-NMR (121.5 MHz, C₆D₆): 16 Signale, Hauptsignal bei δ=33.3 ppm.

### Embodiment 7

### Synthesis of [(η⁵-C₅H₄PPh₂NDip)ZrBr₄]

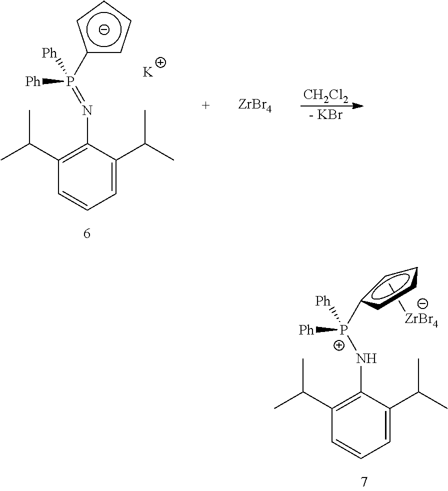

888 mg ZrBr₄ (2.16 mmol, 1.00 eq) was suspended in 25 mL dichloromethane and 1.00 g C₅H₄PPh₂NDipK (2.16 mmol, 1.00 eq) was added portionwise in solid form at −78° C. It was warmed to RT during 12 to 16 hours, whereby a dark brown suspension was formed. The suspension was centrifuged and the supernatant dark brown solution was decanted and discarded. The solution was removed under high vacuum. The bright brown remainder is insoluble in hexane and Et₂O, difficult to dissolve in toluene and benzene, but soluble in dichloromethane, chloroform and THF.

Yield: 820 mg (45%).

CHN: C₂₉H₃₂Br₄NPZr MW: 836.39 g/mol

| | | found | found |
|---|---|---|---|
| | calculated | (1^{st} measurement) | (2^{nd} measurement) |
| C | 41.64 | 48.37 | 47.96 |
| H | 3.86 | 5.20 | 5.52 |
| N | 1.67 | 2.12 | 2.12 |

¹H-NMR (300.1 MHz, CDCl₃): δ=0.91 (br, s, 12H, Me₂CH), 3.13 (sept, 4H, ³J_{HH}=6.9 Hz, Me₂CH), 3.66 (br, s, 1H, H_{Cp}), 6.72 (br, s, 1H, H_{Cp}), 6.96 (d, ³J_{HH}=7.8 Hz, 2H, m-Dip), 7.13 (m, 1H, p-Dip), 7.15 (br, s, 1H, H_{Cp}), 7.21 (br, s, 1H, H_{Cp}), 7.47-7.53 (m, 4H, o-Ph),

7.60-7.68 (m, 6H, m-/p-Ph), 9.79 (d, ²J_{HP}=6.9 Hz, NH) ppm.

¹³C-NMR (75.5 MHz, CDCl₃): δ=23.8 (s, Me₂CH), 29.4 (s, Me₂CH), 46.2 (d, ^{2/3}J_{CP}=12.6 Hz, C_{Cp}), 124.0 (s, m-Dip), 128.4 (s, p-Dip), 129.3 (d, ²J_{CP}=14.7 Hz, o-Ph), 132.6 (d, ^{2/3}J_{CP}=18.6 Hz, C_{Cp}), 133.5 (d, ³J_{CP}=10.9 Hz, m-Ph), 134.2 (d, ⁴J_{CP}=2.7 Hz, p-Ph), 146.9 (d, ^{2/3}J_{CP}=9.1 Hz, C_{Cp}), 148.6 (d, ³J_{CP}=3.4 Hz, o-Dip), 156.1 (d, ^{2/3}J_{CP}=14.8 Hz, C_{Cp}) ppm.

The signals of the ipso-C atoms cannot be observed in the ¹³C-NMR spectrum.

³¹P-NMR (81.0 MHz, CDCl₃): δ=27.3 ppm.

El/MS (70 eV)): m/z (%)=425 (17.2) [Ligand⁺], 382 (21.1) [Ligand⁺-CHMe₂], 177 (35.3) [Dip⁺], 162 (87.8) [Me₂Ph⁺].

ESI/MS (ACN): m/z (%)=785.4 (29), 614.4 (11), 454.2 (9), 426.2 (100) [ligand+H⁺].

### Embodiment 8

### Synthesis of [(η⁵:η¹-C₅Me₄PMe₂NAd)ZrBr₃]

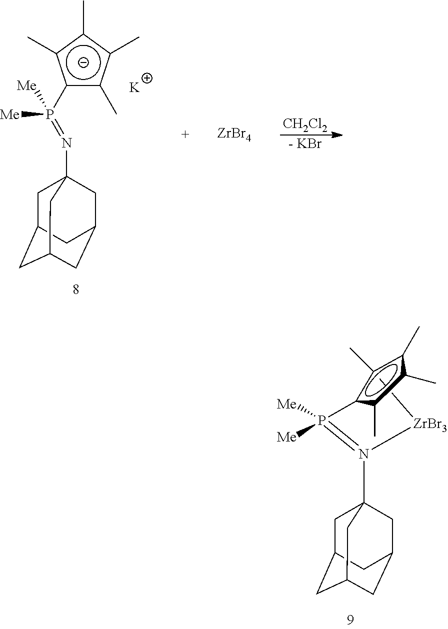

400 mg ZrBr₄ (0.97 mmol, 1.00 eq) was suspended in 10 mL dichloromethane and 360 mg C₅Me₄PMe₂NAdK (0.97 mmol, 1.00 eq) was added at −78° C. It was warmed to RT during 12 to 16 hours, whereby a bright brown suspension was formed. The suspension was centrifuged and the supernatant black solution was decanted. After removal of the solvent under high vacuum, a bright brown solid was obtained. The solid is insoluble in toluene, benzene, hexane and Et₂O, but soluble in dichloromethane and chloroform.

³¹P-NMR (81.0 MHz, CDCl₃): δ=main signal at 26.0 ppm (63%), four other signals at: 72.7 (7%), 57.8 (7%), 53.7 (7%), 44.9 (16%) ppm.

### Embodiment 9

### Synthesis of [(η⁵:η¹-C₅H₄PPh₂NDip)ZrBr₃]

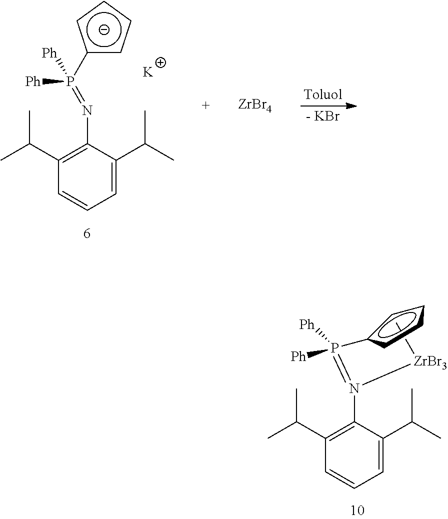

311 mg ZrBr₄ (0.67 mmol, 1.00 eq) was suspended in 7 mL toluene and 275 mg C₅H₄PPh₂NDipK (0.67 mmol, 1.00 eq) was added at -78° C. It was warmed to RT during 12 to 16 hours, whereby a brown suspension was formed. The brown precipitate was filtered off and washed with 3×5 mL toluene.

The filtrate was reduced to dryness. A bright brown solid remained as remainder.

³¹P-NMR (81.0 MHz, C₆D₆): δ=main signal at 28.0 ppm (48%), five other signals at: 31.4 (9%), 28.70 (11%), 28.5 (15%), 14.7 (13%), 13.9 (4%) ppm.

### Embodiment 10

### Synthesis of [(η⁵:η¹-C₅Me₄PMe₂NAd)ZrCl₃]

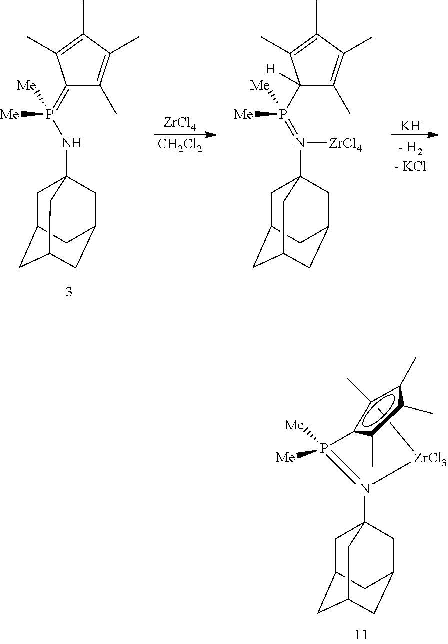

1.00 g C₅Me₄PMe₂NHAd (3.63 mmol, 1.00 eq) was dissolved in 40 mL Dichloromethane and 846 mg ZrCl₄ was added in solid form at −78° C. A change in color from orange to beige occurred immediately. The mixture was heated during 12 to 16 hours to RT, whereby a small amount of white precipitate was formed in a burgundy-colored solution. After removal of the solvent under high vacuum, the remainder was dissolved in 30 mL THF and 364 mg KH (9.1 nmol, 2.51 eq) was added. After stirring for 12 to 16 hours at 40° C., the solvent was removed under high vacuum. The pink-colored solid is insoluble in hexane, Et₂O and toluene, but soluble in dichloromethane, chloroform and THF.

³¹P-NMR (81.0 MHz, CDCl3): δ=main signal at 37.4 ppm (68%), three other signals at: 30.3 (18%), 28.9 (7%), 28.1 (7%) ppm.

### Embodiment 11

### Synthesis of [(η⁵:η¹-Cp™PPh₂NAd)ZrCl₃]

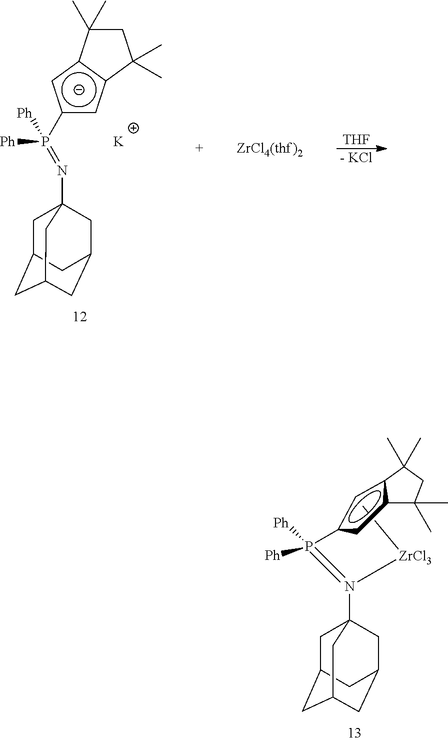

A solution of 1.38 g Cp™ PPh₂NAdK (2.59 mmol, 1.00 eq) in 20 mL THF was added to a solution of 975 mg [ZrCl₄(thf)₂] (2.59 mmol, 1.00 eq) in 10 mL THF, which had been cooled to −78° C. The black-brown solution was warmed to RT during 12 to 16 hours, whereby a white precipitate was formed. It was filtered over Celite and the filtrate was reduced to dryness. The remainder was suspended in 50 mL hexane, filtered over a fritted funnel, washed twice with 10 mL hexane each and finally dried in high vacuum. The purple solid is insoluble in hexane, difficult to dissolve in benzene and toluene, but soluble in dichloromethane, chloroform and THF.

³¹P-NMR (81.0 MHz, CDCl₃): δ=main signal at 37.8 ppm (59%), another signal at 22.0 (41%)

### Embodiment 12

### Synthesis of [(η⁵:η¹-C₅H₄PPh₂NDip)Zr(CH₂SiMe₃)₃]

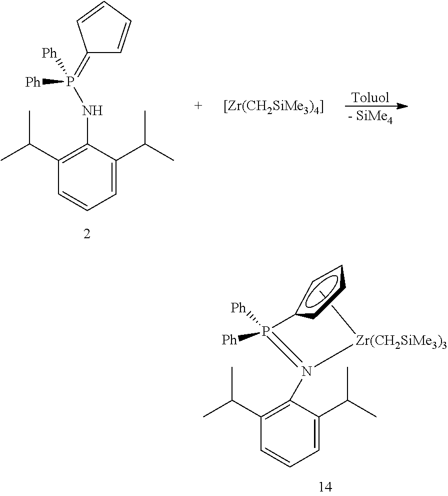

A solution of 731 mg [Zr(CH₂SiMe₃)₄] (1.66 mmol, 1.00 eq) in 10 mL toluene was cooled to −78° C. and a suspension, also pre-cooled to −78°, of 706 mg C₅H₄PPh₂NHDip (1.66 mmol, 1.00 eq) in 5 mL toluene was added. The bright yellow suspension was warmed to RT during 12 to 16 hours, whereby an orange-colored solution was formed. The solvent was removed in high vacuum and the orange-yellow raw product was recrystallized twice from hexane at −80° C. The yellow solid is difficult to dissolve in pentane and hexane, but soluble in benzene and toluene.

Yield: 474 mg (37%).

CHN: C₄₁H₆₄NPSi₃Zr MW: 777.41 g/mol

| | | found | found |
|---|---|---|---|
| | calculated | (1^{st} measurement) | (2^{nd} measurement) |
| C | 63.34 | 54.45 | 54.72 |
| H | 8.30 | 5.83 | 6.11 |
| N | 1.80 | 1.75 | 1.76 |

¹H-NMR (300.1 MHz, C₆D₆): δ=0.20 (s, 27H, Si(CH₃)₃), 0.89 (s, 6H, Zr—CH₂—Si), 1.11 (d, ³J_{HH}=7.0 Hz, 12H, Me₂CH), 3.69 (sept, 2H, ³J_{HH}=7.4 Hz, Me₂CH), 6.43 (m, 2H, H_{Cp}), 6.65 (m, 2H, H_{Cp}), 6.99 (m, 6H, m-/p-Ph), 7.03 (m, 2H, m-Dip), 7.13 (m, 1H, p-Dip), 7.42-7.49 (m, 4H, o-Ph) ppm.

¹³C-NMR (75.5 MHz, C₆D₆): δ=3.0 (s, Si(CH₃)₃), 24.2 (Me₂CH), 29.2 (Me₂CH), 66.6 (s, Zr—CH₂—Si), 114.7 (d, ^{2,3}J_{CP}=11.8 Hz, C_{Cp}), 115.5 (d, ^{2,3}J_{CP}=7.6 Hz, C_{Cp}), 120.8 (d, J_{CP}=2.0 Hz, p-Dip), 123.4 (d, ⁴J_{CP}=2.1 Hz, m-Dip), 128.7 (s, p-Ph), 131.5 (d, ³J_{CP}=2.3 Hz, m-Ph), 132.2 (d, ²J_{CP}=9.5 Hz, o-Ph) ppm.

The signals of the ipso-C atoms cannot be observed in the ¹³C-NMR spectrum.

³¹P-NMR (81.0 MHz, C₆D₆): δ=−10.9 ppm.

EI/MS (70 eV): m/z (%)=763 (4.2) [(C₅H₄PPh₂NDip)Zr(CH₂SiMe₃)₂(CH₂SiMe₂)⁺], 692 (100.0) [(C₅H₄PPh₂NDip)Zr(CH₂SiMe₃)₂⁺], 514 (77.4), 473 (76.5), 425 (2.9) [ligand⁺].

IR (Nujol): 1244 [v (P═N)] (s), 1225 (m), 1186 (s), 1049 (m), 744 (s), 704 [v (P—C)] (s), 696 (w), 517 (w), 465 [v Zr—C] (m) cm⁻¹.

Crystal Structure Analysis

Crystal data

| | |
|---|---|
| Identification code | eq26r |
| Habitus, color | block-type, colorless |
| Crystal size | 0.33 × 0.24 × 0.21 mm³ |
| Crystal system | monoclinic |
| Space group | I 2/a Z = 8 |
| Unit cell dimensions | a = 18.9452(17) Å α = 90°, |
| | b = 22.259(3) Å β = 102.343(11)°, |
| | c = 21.1392(19) Å γ = 90°. |
| Volume | 8708.3(15) Å³ |
| Cell determination | 7997 peaks with theta 1.9 to 26°. |
| Empirical formula | C32.80H51.20N0.80P0.80Si2.40Zr0.80 |
| Formula mass | 621.91 |
| Density (calculated) | 1.186 Mg/m³ |
| Absorption coefficient | 0.399 mm⁻¹ |

Data collection

| | |
|---|---|
| Diffractometer type | IPDS1 |
| Wavelength | 0.71073 Å |
| Temperature | 293(2) K |
| Theta-range for data collection | 1.83 to 25.98°. |
| Index ranges | −23 <= h <= 23, −27 <= k <= 27, |
| | −25 <= l <= 25 |
| Data collection software | STOE Expose |
| Cell refinement software | STOE Cell |
| Data reduction software | STOE Integrate |

Resolution and refinement

| | |
|---|---|
| Reflections | 47882 |
| Independent reflections | 8356 [R(int) = 0.0385] |
| Completeness to theta = 25.00° | 98.3% |
| Observed reflections | 6279[I > 2sigma(I)] |
| Reflections used for refinement | 8356 |
| Absorption correction | Empirical (SHELXA) |
| Max. and min. transmission | 0.9167 and 0.7062 |
| Largest differential | 0.383 and −0.419 e, Å⁻³ |
| peak and hole | |
| Solution | direct/difmap |
| Refinement | Least-squares on F² method |
| Treatment of H atoms | mixed |
| Programs used | SHELXS-86 (Sheldrick, 1986) |
| | SHELXL-97 (Sheldrick, 1997) |
| | Diamond 2, 1, STOE IPDS1 software |
| Data/restrictions/parameters | 8356/0/424 |
| Goodness-of-fit-on F² | 0.899 |
| R index (all data) | wR2 = 0.0712 |
| R index conventional | R1 = 0.0284 |
| [I > 2sigma(I)] | |

F(000) 3312

### Embodiment 13

### Synthesis of [(η⁵:η¹-C₅H₄PMe₂NDip)Zr(CH₂SiMe₃)₃]

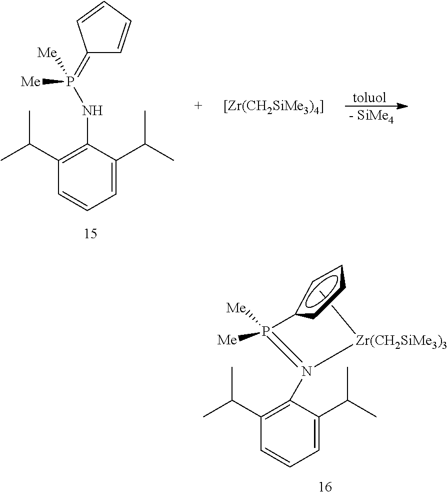

1.46 g [Zr(CH₂SiMe₃)₄] (3.32 mmol, 1.00 eq) was dissolved in 45 mL toluene and 1.00 g C₅H₄PMe₂NHDip (3.32 mmol, 1.00 eq) was added portionwise in solid form at −78° C. It was warmed to RT during 12 to 16 hours, whereby a reddish brown solution was formed. The solvent was removed in high vacuum and the orange-yellow remainder was recrystallized from hexane at −30° C. The apricot-colored solid is difficult to dissolve in pentane and hexane, but soluble in benzene and toluene.

Yield: 1.66 g (77%).

CHN: C₃₁H₆₀NIPSi₃Zr MW: 653.27 g/mol

| | | found | found |
|---|---|---|---|
| | calculated | (1^{st} measurement) | (2^{nd} measurement) |
| C | 57.00 | 51.14 | 53.73 |
| H | 9.26 | 8.02 | 8.50 |
| N | 2.14 | 2.12 | 2.08 |

¹H-NMR (300.1 MHz, C₆D₆): δ=0.36 (s, 27H, Si(CH₃)₃), 0.91 (s, 6H, Zr—CH₂—Si), 1.06 (d, ²J_{HP}=12.3 Hz, PMe₂), 1.32 (d, ³J_{HH}=6.8 Hz, 12H, Me₂CH), 3.20 (sept, 2H, ³J_{HH}=6.8 Hz, Me₂CH), 6.48 (m, 2H, H_{Cp}), 6.76 (m, 2H, H_{Cp}), 7.13 (m, 2H, m-Dip), 7.24 (m, 1H, p-Dip) ppm.

¹³C-NMR (75.5 MHz, C₆D₆): δ=3.7 (s, Si(CH₃)₃), 15.4 (d, ¹J_{CP}=59.6 Hz, PMe₂), 25.5 (Me₂CH), 28.0 (Me₂CH), 61.4 (s, Zr—CH₂—Si), 110.0 (d, ^{2,3}J_{CP}=13.1 Hz, C_{CP}), 118.8 (d, ^{2,3}J_{CP}=12.8 Hz, C_{Cp}), 123.2 (d, ⁵J_{CP}=3.4 Hz, p-Dip), 124.4 (d, ⁴J_{CP}=3.6 Hz, m-Dip), 144.9 (d, ³J_{CP}=6.4 Hz, o-Dip) ppm.

The signal of the ipso-C_{Cp} atom cannot be observed in the ¹³C-NMR spectrum.

³¹P-NMR (81.0 MHz, C₆D₆): δ=10.2 ppm.

EI/MS (70 eV): m/z (%)=642 (2.8) [(C₅H₄PMe₂NDip)Zr(CH₂SiMe₃)₂(CH₂SiMe₂)⁺], 564 (0.9) [(C₅H₄PMe₂NDip)Zr(CH₂SiMe₃)₂⁺], 515 (4.1), 301 (3.6) [ligand⁺], 177 (34.1) [Dip⁺], 162 (100) [Me₂Ph⁺].

IR (Nujol): 2361 (w), 1240 [v (P═N)] (s), 1225 (m), 1190 (s), 1047 (s), 743 (s), 710 [v (P—C)] (s), 696 (w), 606 (w), 517 (w), 583 (w), 488 (m), 451 [v (Zr—C)] (s) cm⁻¹.

Crystal Structure Analysis

Crystal data

| Identification code | eq55 |
|---|---|
| Habitus, color | colorless |
| Crystal size | 0.36 × 0.3 × 0.21 mm³ |
| Crystal system | monoclinic |
| Space group | P 21/cZ = 4 |
| Unit cell dimensions | a = 10.8463(10) Å α = 90°. |
| | b = 19.9277(14) Å β = 101.856(10)°. |
| | c = 17.7542(15) Å γ = 90°. |
| Volume | 3755.6(5) Å³ |
| Cell determination | 8000 peaks with theta 2.0 to 26°. |
| Empirical formula | C31H60NPSi3Zr |
| Formula mass | 653.26 |
| Density (calculated) | 1.155 Mg/m³ |
| Absorption coefficient | 0.450 mm⁻¹ |
| F(000) | 1400 |

Data collection

| | |
|---|---|
| Diffractometer type | IPDS1 |
| Wavelength | 0.71073 Å |
| Temperature | 293(2) K |
| Theta-range for data collection | 1.92 to 26.03°. |
| Index ranges | −13 <= h <= 13, −23 <= k <= 24, |
| | −21 <= l <= 21 |
| Data collection software | STOE Expose |
| Cell refinement software | STOE Cell |
| Data reduction software | STOE Integrate |

Resolution and refinement

| | |
|---|---|
| Reflections collected | 21053 |
| Independent reflections | 7324 [R(int) = 0.0326] |
| Completeness to theta = 25.00° | 99.8% |
| Observed reflections | 5088[I > 2sigma(I)] |
| Reflections used for refinement | 7324 |
| Absorption correction | semi-empirical |
| Max. and min. transmission | 0.8837 and 0.8642 |
| Largest peak difference and hole | 1.040 und −0.506 e, Å⁻³ |
| Solution | direct/difmap |
| Refinement | Least-squares on F² method |
| Treatment of H atoms | mixed |
| Programs used | SHELXS-97 (Sheldrick, 1997) |
| | SHELXL-97 (Sheldrick, 1997) |
| | Diamond 2, 1, STOE IPDS1 software |
| Data/restrictions/parameters | 7324/0/334 |
| Goodness-of-fit-on F² | 0.890 |
| R index (all data) | wR2 = 0.0885 |
| R index conventional | R1 = 0.0357 |
| [I > 2sigma(I)] | |

### Embodiment 14

### Synthesis of [(η⁵:η¹-C₅Me₄PMe₂NAd)Zr(CH₂SiMe₃)₃] in toluene

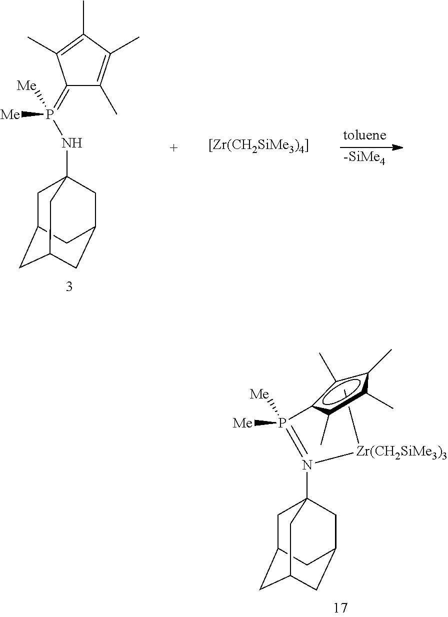

224 mg (0.51 mmol) [Zr(CH₂SiMe₃)₄] was dissolved in 15 mL toluene and cooled to −78° C. To this solution, a suspension of 190 mg (0.51 mmol) C₅Me₄PMe₂NHAd in 15 mL toluene, which had also been cooled to −78°, was added. The mixture was stirred for 6 h at −78° C., during which a clear pale orange solution was formed.

The solution was subsequently warmed to RT. Removal of the solvent and drying in high vacuum resulted in an orange-yellow solid that is soluble in pentane, hexane, toluene and THF.

Yield: 338 mg (97%)

CHN: C₃₃H₆₆NPSi₃Zr FW 683.34 g/mol

| | | found | found |
|---|---|---|---|
| | calculated | (1^{st} measurement) | (2^{nd} measurement) |
| C | 58.00 | 46.82 | 47.29 |
| H | 9.74 | 6.68 | 8.32 |
| N | 2.05 | 2.19 | 2.12 |

¹H-NMR (300.1 MHz, C₆D₆): δ=0.35 (s, 27H, —Si—(CH₃)₃), 0.43 (s, 6H, Zr—CH₂—Si), 1.28 (d, ²J_{PH}=12.0 Hz, 6H, Me₂P), 1.71-1.59 (br, m, 6H, CH—CH₂—CH), 1.89 (br, d, ³J_{HH}=3.6 Hz, 6H, N—C(CH₂)₃), 1.99 (s, 6H, C₅Me₄), 2.1 (br, m, 3H, CH_{Ad}), 2.06 (s, 6H, C₅Me₄) ppm.

¹³C-NMR (75.5 MHz, C₆D₆): δ=4.4 (s, —Si—Me₃), 12.4 (s, C₅Me₄), 23.0 (d, ¹J_{CP}=50.6 Hz, Me₂P), 14.8 (s, C₅Me₄), 30.8 (d, ⁴J_{PC}=1.6 Hz, CH_{Ad}), 36.9 (s, CH—CH₂—CH), 48.0 (d, ³J_{CP}=10.4 Hz, N—C(CH₂)₃), 54.6 (d, ²J_{CP}=5.5 Hz, P═N—C_{Ad}), 60.6 (s, Zr—CH₂—Si), 121.8 (d, ^{2,3}J_{CP}=12.3 Hz, C(Me)═C(Me)), 126.4 (d, ^{2,3}J_{CP}=12.6 Hz, C(Me)═C(Me)) ppm.

The signal of the ipso-C_{Cp} cannot be observed in the ¹³C-NMR spectrum.

³¹P-NMR (121.5 MHz, C₆D₆): δ=29.9 ppm.

EI/MS (70 eV): m/z (%)=332 (1) [ligand⁺], 170 (25.7), 150 (13.4) [N-Ad⁺], 135 (35.7) [Ad⁺], 94 (42.3), 79 (11.5), 77 (16.3) [Me₂PN⁺], 41 (11.0).

IR (Nujol): wave number=3470 (m), 1377 (m), 1303 (m), 1260 [v (P═N)], 1242 (m), 1099 (m), 904 s, 852 (m) cm⁻¹.

### Embodiment 15

### Synthesis of [(η⁵:η¹-C₅Me₄PMe₂NAd)Zr(CH₂SiMe₃)₃] in hexane

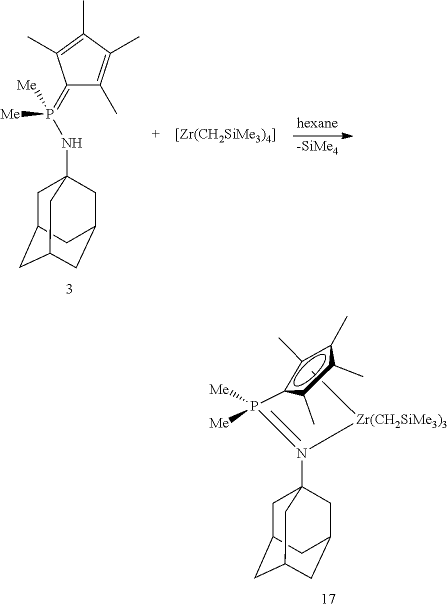

1.00 g [Zr(CH₂SiMe₃)₄] (2.27 mmol, 1.00 eq) was dissolved in 50 mL hexane and 626 mg C₅Me₄PMe₂NHAd (2.27 mmol, 1.00 eq) was added portionwise in solid form at −78° C. It was warmed to RT during 12 to 16 hours, whereby a pale orange-colored solution was formed. The solvent was removed in high vacuum and the orange-yellow remainder was recrystallized from hexane at −30° C. The apricot-colored solid is difficult to dissolve in pentane and hexane, but soluble in benzene and toluene.

Yield: 534 mg (34%).

CHN: C₃₃H₆₆NPSi₃Zr MW: 683.34 g/mol

| | | found | found |
|---|---|---|---|
| | calculated | (1^{st} measurement) | (2^{nd} measurement) |
| C | 58.00 | 53.20 | 53.40 |
| H | 9.74 | 7.97 | 7.88 |
| N | 2.05 | 1.76 | 1.82 |

¹H-NMR (300.1 MHz, C₆D₆): δ=0.39 (s, 27H, Si(CH₃)₃), 0.51 (s, 6H, Zr—CH₂—Si), 1.29 (d, ²J_{HP}=12.0 Hz, 6H, PMe₂), 1.67 (br, m, 6H, CH_{2Ad}), 1.92 (br, m, 6H, N—C(CH₂)₃), 2.00 (s, 6H, C(Me)═C(Me), 2.09 (br, m, 3H, CH_{Ad}; 6H, C(Me)═C(Me) ppm.

¹³C-NMR (75.5 MHz, C₆D₆): δ=4.4 (s, Si(CH₃)₃), 12.5 (s, C(Me)═C(Me)), 14.9 (s, C(Me)═C(Me)), 23.0 (d, ¹J_{CP}=50.6 Hz, PMe₂), 30.8 (s, CH_{Ad}), 36.9 (s, CH_{2Ad}), 48.1 (d, ³J_{CP}=10.3 Hz, N—C(CH₂)₃), 54.6 (d, ²J_{CP}=4.8 Hz, P═N—C_{Ad}), 61.0 (s, Zr—CH₂—Si), 121.8 (d, ^{2,3}J_{CP}=12.2 Hz, C(Me)═C(Me)), 126.4 (d, ^{2,3}J_{CP}=12.7 Hz, C(Me)═C(Me)) ppm.

The signal of the ipso-C_{Cp} atom cannot be observed in the ¹³C-NMR spectrum.

³¹P-NMR (81.0 MHz, C₆D₆): δ=2.1 ppm.

EI/MS (70 eV): m/z (%)=331 (1.6) [ligand⁺], 211 (1.8) [Me₂PNAd⁺], 94 (1.6), 73 (100.0).

IR (Nujol): 1260 [v (P═N)] (m), 860 (m), 721 (w) [v (P—C)] (s), 669 (w), 449 [v (Zr—C)] (m) cm^{-1.}

Crystal Structure Analysis

Crystal data

| Identification code | eq77 |
|---|---|
| Habitus, color | round, colorless |
| Crystal size | 0.57 × 0.15 × 0.15 mm³ |
| Crystal system | monoclinic |
| Space group | C 2/c Z = 4 |
| Unit cell dimensions | a = 39.944(4) Å α = 90°. |
| | b = 10.3379(8) Å β = 91.878(13)°. |
| | c = 18.527(2) Å γ = 90°, |
| Volume | 7646.2(13) Å³ |
| Cell determination | 8000 peaks with theta 2 to 25.5°. |
| Empirical formula | C66H132N2P2Si6Zr2 |
| Formula mass | 1366.66 |
| Density (calculated) | 1.187 Mg/m³ |
| Absorption coefficient | 0.445 mm⁻¹ |
| F(000) | 2944 |

Data collection

| | |
|---|---|
| Diffractometer type | IPDS1 |
| Wavelength | 0.71069 Å |
| Temperature | 293(2) K |
| Theta-range for data collection | 2.03 to 26.06°. |
| Index ranges | −49 <= h <= 49, −12 <= k <= 12, |
| | −22 <= l <= 22 |
| Data collection software | STOE Expose |
| Cell refinement software | STOE Cell |
| Data reduction software | STOE Integrate |

Resolution and refinement:

| | |
|---|---|
| Reflections collected | 37191 |
| Independent reflections | 7477 [R(int) = 0.0474] |
| Completeness to theta = 25.00° | 99.5% |
| Observed reflections | 5901[I > 2sigma(I)] |
| Reflections used for refinement | 7477 |
| Absorption correction | semi-empirical |
| Max. and min. transmission | 0.9207 and 0.8516 |
| Largest differential peak and hole | 0.463 and −0.340 e, Å⁻³ |
| Solution | direct/difmap |
| Refinement | Least-squares on F² method |
| Treatment of H atoms | mixed |
| Programs used | SHELXS-86 (Sheldrick, 1986) |
| | SHELXL-97 (Sheldrick, 1997) |
| | Diamond 2.1, STOE IPDS1 software |
| Data/restrictions/parameters | 7477/0/369 |
| Goodness-of-fit-on F² | 0.930 |
| R index (all data) | wR2 = 0.0784 |
| R index conventional | R1 = 0.0308 |
| [I > 2sigma(I)] | |

### Embodiment 16

### Synthesis of [(η⁵:η¹-Cp™ PPh₂NAd)Zr(CH₂SiMe₃)₃]

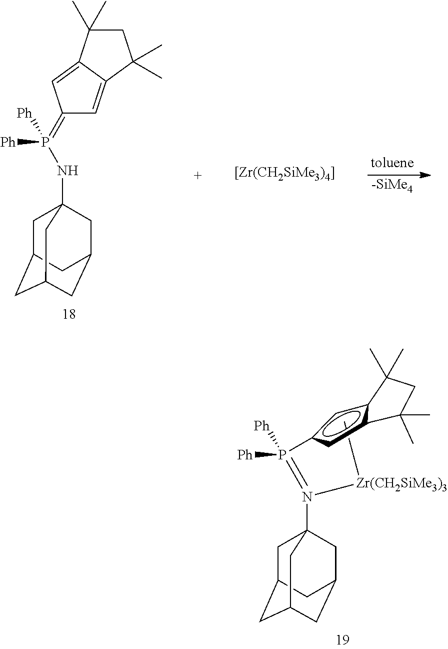

88 mg [Zr(CH₂SiMe₃)₄] (0.20 mmol, 1.00 eq) was dissolved in 5 mL toluene and 100 mg Cp™ PPh₂NHAd (2.27 mmol, 1.00 eq) was added portionwise in solid form at −78° C., whereby an orange colored solution was formed. It was warmed to RT during 12 to 16 hours and heated to 60° C. for 7 days. The solvent was removed in high vacuum. The orange-yellow remainder is highly soluble in hexane and toluene, even at −80° C.

³¹P-NMR (81.0 MHz, toluene): δ=16.6 (43%) [ligand], 13.7 (57%) ppm.

### Embodiment 17

### Synthesis of [(η⁵:η¹-Cp™ PPh₂NDip)Zr(CH₂SiMe₃)₃]

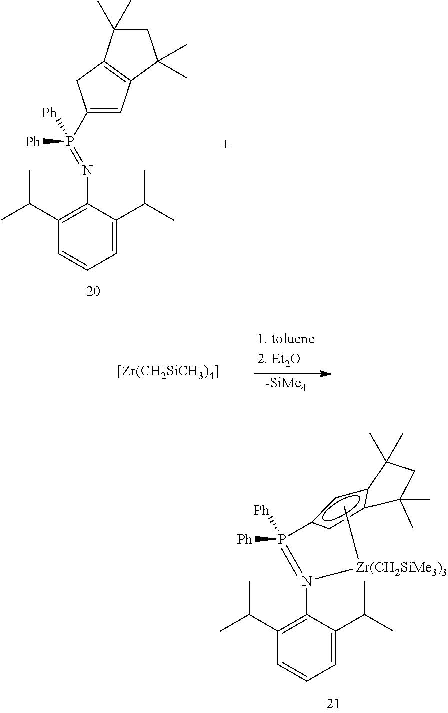

295 mg [Zr(CH₂SiMe₃)₄] (0.67 mmol, 1.00 eq) was dissolved in 10 mL toluene and 350 mg CpH™ PPh₂NDip (0.67 mmol, 1.00 eq) was added portionwise in solid form at −78° C., whereby a yellow solution was formed. It was warmed to RT during 12 to 16 hours. The solvent was removed in high vacuum and the yellow remainder was dissolved in 5 mL Et₂O and stirred for 4 h at RT.

³¹P-NMR (81.0 MHz, Et₂O): δ=−9.3 (9%), −11.7 (26%), −14.8 (65%) [ligand] ppm.

### Embodiment 18

### Synthesis of [(η⁵:η¹-C₅Me₄PMe₂NAd)Zr(CH₂Ph)₃]

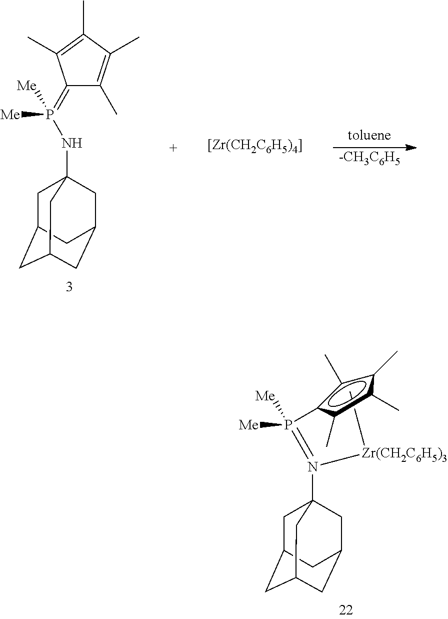

242 mg [Zr(CH₂C₆H₅)₄] (0.53 mmol) was dissolved in 10 mL toluene and cooled to −78° C. To this solution, a suspension of 196 mg (0.53 mmol) C₅Me₄PMe₂NHAd in 10 mL toluene, which had also been cooled to −78°, was added. The mixture was warmed to RT and stirred for 12 to 16 hours. A clear red solution was formed. Removal of the solvent resulted in a red solid that is insoluble in pentane and hexane, but soluble in toluene, benzene and THF.

Yield: 361 mg (97%)

CHN: C₄₂H₅₄NPZr FW 695.08 g/mol

| | | found | found |
|---|---|---|---|
| | calculated | (1^{st} measurement) | (2^{nd} measurement) |
| C | 72.57 | 59.30 | 62.75 |
| H | 7.83 | 7.26 | 9.68 |
| N | 2.02 | 2.71 | 2.70 |

¹H-NMR (300.1 MHz, C₆D₆): δ=1.21 (d, ²J_{HP}=12.87 Hz, 6H, Me₂P), 1.35 (br, m, 6H, CH—CH₂—CH), 1.65 (s, CH₂—Zr), 2.04 (d, 6H, ³J_{HH}=1.36 Hz, N—C(CH₂)₃), 2.36 (s, 6H, C₅Me₄), 2.41 (d, ^{4,5}J_{HP}=7.75 Hz, 6H, C₅Me₄; 3H, CH_{Ad}), 7.20-6.80 (m, 15 H, Ph) ppm.

¹³C-NMR (75.5 MHz, C₆D₆): δ=12.1 (d, ^{3,4}J_{CP}=3.0 Hz, C₅Me₄), 14.9 (s, C₅Me₄), 19.4 (d, ¹J_{CP}=69.8 Hz, Me₂P), 21.4 (s, Zr—CH₂—Ph), 29.9 (s, CH_{Ad}), 36.1 (s, CH—CH₂—CH), 44.8 (d, ³J_{CP}=4.1 Hz, N—C(CH₂)₃), 52.5 (d, ²J_{CP}=4.4 Hz, P—N—C_{Ad}), 117.7 (d, ^{2,3}J_{CP}=16.6 Hz, C(Me)═C(Me)), 120.7 (d, ^{2,3}J_{CP}=19.6 Hz, C(Me)═C(Me)), 125.6 (Bzₚₐᵣₐ), 128.5 (Bzₘₑₜₐ), 129.3 (Bzₒᵣₜₕₒ), 137.8 (Bzᵢₚₛₒ) ppm. The signal of the ipso-C_{Cp} cannot be observed in the ¹³C-NMR spectrum.

³¹P-NMR (121.5 MHz, C₆D₆): δ=29.9 ppm.

EI/MS (70 eV): m/z (%)=331 (25.2) [ligand⁺], 211 (100) [Me₂PNAd⁺], 196 (57) [MePNAd⁺], 170 (10), 154 (37), 150 (12) [NAd⁺], 135 (73) [Ad⁺], 105 (21), 94 (72), 91 (22) [Bz⁺], 79 (36), 77 (31) [Ph⁺], 61 (18), 55 (11), 41 (35).

IR (Nujol): wave number=3470 (w), 2726 [v (C—CH₃)] (m), 2281 (m), 1377 [v (C—C)] (m), 1303 [v (P═N)] (s), 1203 (m), 1154 (s), 1096 (m), 1035 (m), 723 [v (P—C)] (s) cm⁻¹.

UV/VIS (THF): λₘₐₓ=279 nm.

### Embodiment 19

### Synthesis of [(η⁵:η¹-C₅H₄PPh₂NDip)Zr(CH₂Ph)₃]

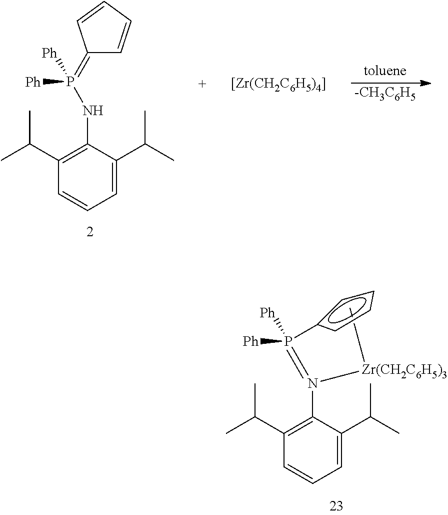

A suspension of 500 mg [Zr(CH₂C₆H₅)₄] (1.09 mmol, 1.00 eq) in 20 mL toluene was cooled to −78° C. and a suspension, also pre-cooled to −78° C., of 464 mg C₅H₄PPh₂NHDip (1.09 mmol, 1.00 eq) in 5 mL toluene was added dropwise. It was was warmed to RT and stirred for 12 to 16 hours, whereby a lemon-yellow suspension and a white precipitate were formed. It was filtered over Celite and the white remainder was washed three times with 5 mL toluene each and the filtrate was reduced to dryness. The yellow-brown remainder is insoluble in hexane, but soluble in benzene, toluene and Et₂O.

Yield: 232 mg (27%).

CHN: C₅₀H₅₂NPZr MW: 789.15 g/mol

¹H-NMR (300.1 MHz, d⁸-THF): δ=0.81 (br, s, 12H, Me₂CH), 2.52 (br, s, Zr—CH₂Ph), 3.37 (m, 2H, Me₂CH), 6.10 (m, 2H, H_{Cp}), 6.57 (m, 2H, H_{Cp}), 6.72 (m, 1H, p-Dip), 6.88 (m, 2H, m-Dip), 7.01-7.19 (m, 15H, CH₂Ph), 7.33-7.42 (m, 6H, m-/p-Ph), 7.61 (m, 4H, o-Ph) ppm.

³¹P-NMR (81.0 MHz, d⁸-THF): δ=13.2 ppm.

³¹P-NMR (81.0 MHz, C₆D₆): δ=14.2 ppm.

### Embodiment 20

### Synthesis of [(η⁵-C₅H₄PPh₂NDip)Zr(NMe₂)₃]

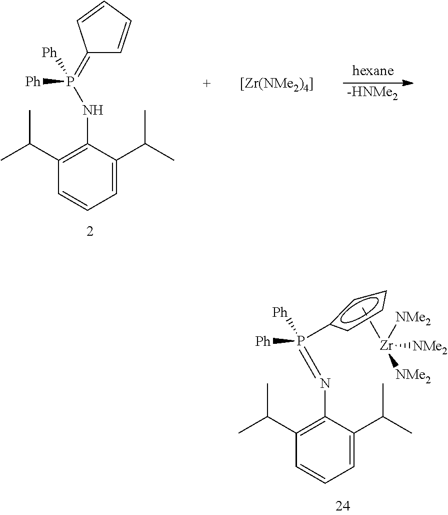

A solution of 629 mg [Zr(NMe₂)₄] (2.35 mmol, 1.00 eq) in 35 mL hexane was cooled to −78° C. and 1.00 mg C₅H₄PPh₂NHDip (2.35 mmol, 1.00 eq) was added portionwise in solid form. It was was warmed to RT and stirred for 12 to 16 hours, whereby a pale yellow solvent and a white precipitate were formed. It was completely concentrated and recrystallized from hexane at −30° C. The white solid is difficult to dissolve in hexane, but soluble in toluene and benzene.

Yield: 904 mg (60%).

CHN: C₃₅H₄₉N₄PZr MW: 647.99 g/mol

| | | found | found |
|---|---|---|---|
| | calculated | (1^{st} measurement) | (2^{nd} measurement) |
| C | 64.87 | 62.31 | 63.26 |
| H | 7.62 | 6.43 | 6.81 |
| N | 8.65 | 6.16 | 7.40 |

¹H-NMR (300.1 MHz, C₆D₆): δ=1.14 (d, ³J_{HH}=6.9 Hz, 12H, Me₂CH), 2.92 (s, 18H, NMe₂), 3.76 (sept, 2H, ³J_{HH}=6.9 Hz, Me₂CH), 6.27 (br, m, 2H, H_{Cp}), 6.59 (br, m, 2H, H_{Cp}), 6.90-7.06 (m, 9H, m-/p-Ph; m-/p-Dip), 7.43 (m, 4H, o-Ph) ppm.

¹³C-NMR (75.5 MHz, C₆D₆): δ=24.1 (Me₂CH), 28.9 (Me₂CH), 45.1 (s, Zr—NMe₂), 113.6 (d, ^{2,3}J_{CP}=12.7 Hz, C_{Cp}), 117.5 (d, ^{2,3}J_{CP}=12.9 Hz, C_{Cp}), 119.9 (d, ⁵J_{CP}=5.7 Hz, p-Dip), 123.2 (d, ⁴J_{CP}=2.6 Hz, m-Dip), 128.2 (s, p-Ph), 130.8 (s, m-Ph), 132.0 (d, ²J_{CP}=9.4 Hz, o-Ph), 142.8 (s, o-Dip) ppm.

The signals of the ipso-C atoms cannot be observed in the ¹³C-NMR spectrum.

³¹P-NMR (81.0 MHz, C₆D₆): δ=−12.4 ppm.

EI/MS (70 eV): m/z (%)=425 (14.0) [ligand⁺], 253 (12.8) [Ph₂PCp⁺], 133 (18.0), 28 (100.0).

IR (Nujol): 2855 [v (N—C)] (s), 1400 [v (P═N)] (s), 702 [v (P—C)] (m), 453 (m), 415 [v (Zr—N)] (s) cm⁻¹.

Crystal Structure Analysis

Crystal data

| Identification code | eq106 |
|---|---|
| Habitus, color | disc-shaped, bright yellow |
| Crystal size | 0.45 × 0.42 × 0.03 mm³ |
| Crystal system | monoclinic |
| Space group | P 21/n, Z = 4 |
| Unit cell dimensions | a = 17.944(2) Å α = 90°. |
| | b = 8.8621(9) Å β = 111.379(10)°. |
| | c = 23.610(3) Å γ = 90°. |
| Volume | 3496.1(8) Å³ |
| Cell determination | 11903 peaks with theta 2.5 to 25.7°. |
| Empirical formula | C35H49N4PZr |
| Formula mass | 647.97 |
| Density (calculated) | 1.231 Mg/m³ |
| Absorption coefficient | 0.388 mm⁻¹ |
| F(000) | 1368 |

Data collection

| | |
|---|---|
| Diffractometer type | IPDS1 |
| Wavelength | 0.71073 Å |
| Temperature | 293(2) K |
| Theta-range for data collection | 2.44 to 25.47°. |
| Index ranges | −21 <= h <= 20, −10 <= k <= 10, |
| | −28 <= I <= 28 |
| Data collection software | STOE Expose |
| Cell refinement software | STOE Cell |
| Data reduction software | STOE Integrate |

Resolution and refinement

| | |
|---|---|
| Reflections collected | 24871 |
| Independent reflections | 6389 [R(int) = 0.0662] |
| Completeness to theta = 25.00° | 99.4% |
| Observed reflections | 4579[I > 2sigma(I)] |
| Reflections used for refinement | 6389 |
| Absorption correction | semi-empirical |
| Max. and min. transmission | 0.967 and 0.8646 |
| Largest difference peak and hole | 0.328 und −0.309 e, Å⁻³ |
| Solution | direct/difmap |
| Refinement | Least-squares on F² method |
| Treatment of H atoms | mixed |
| Programs used | SHELXS-97 (Sheldrick, 1997) |
| | SHELXL-97 (Sheldrick, 1997) |
| | Diamond 2, 1, STOE IPDS1 software |
| Data/restrictions/parameters | 6389/0/370 |
| Goodness-of-fit-on F2 | 0.857 |
| R index (all data) | wR2 = 0.0611 |
| R index conventional | R1 = 0.0312 |
| [I > 2sigma(I)] | |

### Embodiment 21

### Synthesis of [(η⁵-C₅H₄PMe₂NDip)Zr(NMe₂)₃]

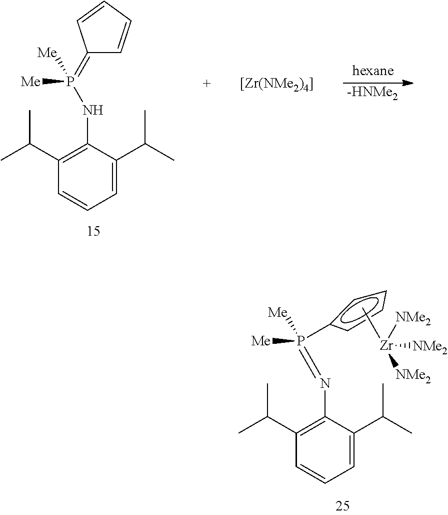

A solution of 682 mg [Zr(NMe₂)₄] (2.55 mmol, 1.00 eq) in 30 mL hexane was cooled to −78° C. and 770 mg C₅H₄PMe₂NHDip (2.55 mmol, 1.00 eq) was added portionwise in solid form. It was was warmed to RT for 12 to 16 hours, whereby a white precipitate was formed. It was completely concentrated. The white solid is difficult to dissolve in hexane, but soluble in toluene and benzene.

Yield: 1.21 g (90%).

CHN: C₂₅H₅₀N₄PZr MW: 528.89 g/mol

| | | found | found |
|---|---|---|---|
| | calculated | (1^{st} measurement) | (2^{nd} measurement) |
| C | 56.77 | 52.45 | 54.07 |
| H | 9.53 | 7.89 | 8.07 |
| N | 10.59 | 8.89 | 9.29 |

¹H-NMR (300.1 MHz, C₆D₆): δ=1.28 (d, ²J_{HP}=12.0 Hz, PMe₂), 1.35 (d, ³J_{HH}=6.8 Hz, 12H, Me₂CH), 2.92 (s, 18H, NMe₂), 3.76 (sept, 2H, ³J_{HH}=6.8 Hz, Me₂CH), 6.09 (br, m, 2H, H_{Cp}), 6.42 (br, m, 2H, H_{Cp}), 7.08 (t, 1H, ³J_{HH}=7.7 Hz, p-Dip), 7.25 (dd, 2H, ³J_{HH}=7.0 Hz, ⁵J_{HP}=1.2 Hz, m-Dip) ppm.

¹³C-NMR (75.5 MHz, C₆D₆): δ=19.0 (d, ²J_{Cp}=62.7 Hz, PMe₂), 24.4 (Me₂CH), 28.5 (Me₂CH), 45.0 (s, Zr—NMe₂), 113.3 (d, ^{2,3}J_{CP}=11.5 Hz, C_{Cp}), 114.4 (d, ^{2,3}J_{CP}=11.9 Hz, C_{Cp}), 119.8 (d, ⁵J_{CP}=4.1 Hz, p-Dip), 123.1 (d, ⁴J_{CP}=3.3 Hz, m-Dip), 142.8 (d, ³J_{CP}=7.6 Hz, o-Dip) ppm.

The signal of the ipso-C_{Cp} atom cannot be observed in the ¹³C-NMR spectrum.

³¹P-NMR (81.0 MHz, C₆D₆): δ=−11.3 ppm.

EI/MS (70 eV): m/z (%)=301 (23.1) [ligand⁺], 286 (26.0) [C₅H₄PMeNDip⁺], 258 (12.0) [C₅H₄PMe₂N(Me₂CHPh)⁺], 177 (28.3) [NDip⁺], 162 (100).

IR (Nujol): 2854 [v (N—C)] (s), 1400 [v (P═N)] (m), 671 [v (P-C)] (w), 465 (m), 440 [v (Zr—N)] (s) cm^{-1.}

Crystal Structure Analysis

Crystal data

| Identification code | eq103 |
|---|---|
| Habitus, color | block-type, colorless |
| Crystal size | 0.36 × 0.12 × 0.09 mm³ |
| Crystal system | triclinic |
| Space group | P −1 Z = 2 |
| Unit cell dimensions | a = 8.2685(14) Å α = 96.14(2)°. |
| | b = 9.0132(17) Å β = 92.18(2)°. |
| | c = 21.211(4) Å γ = 94.00(2)°. |
| Volume | 1566.2(5) Å³ |
| Cell determination | 8000 peaks with theta 3.0 to 26.0°. |
| Empirical formula | C28.50H49N4PZr |
| Formula mass | 569.91 |
| Density (calculated) | 1.208 Mg/m³ |
| Absorption coefficient | 0.424 mm⁻¹ |
| F(000) | 606 |

Data collection

| | |
|---|---|
| Diffractometer type | IPDS1 |
| Wavelength | 0.71069 Å |
| Temperature | 293(2) K |
| Theta-range for data collection | 1.93 to 26.00°. |
| Index ranges | −10 <= h <= 10, −11 <= k <= 11, |
| | −25 <= l <= 26 |
| Data collection software | STOE Expose |
| Cell refinement software | STOE Cell |
| Data reduction software | STOE Integrate |

Resolution and refinement:

| | |
|---|---|
| Reflections collected | 15444 |
| Independent reflections | 5714 [R(int) = 0.0685] |
| Completeness to theta = 25.00° | 94.2% |
| Observed reflections | 4144[I > 2sigma(I)] |
| Reflections used for refinement | 5714 |
| Absorption correction | semi-empirical |
| Max. and min. transmission | 0.9924 and 0.8993 |
| Largest difference peak and hole | 0.634 and −0.668 e, Å⁻³ |
| Solution | direct/difmap |
| Refinement | Least-squares on F² method |
| Treatment of H atoms | mixed |
| Programs used | SIR97 (Giacovazzo et al, 1997) |
| | SHELXL-97 (Sheldrick, 1997) |
| | Diamond 2, 1, STOE IPDS1 software |
| Data/restrictions/parameters | 5714/2/332 |
| Goodness-of-fit-on F² | 0.915 |
| R index (all data) | wR2 = 0.1035 |
| R index conventional | R1 = 0.0423 |
| [I > 2sigma(I)] | |

### Embodiment 22

### Synthesis of [(η¹:η¹-C₅Me₄PMe₂NAd)Zr(NMe₂)₃]

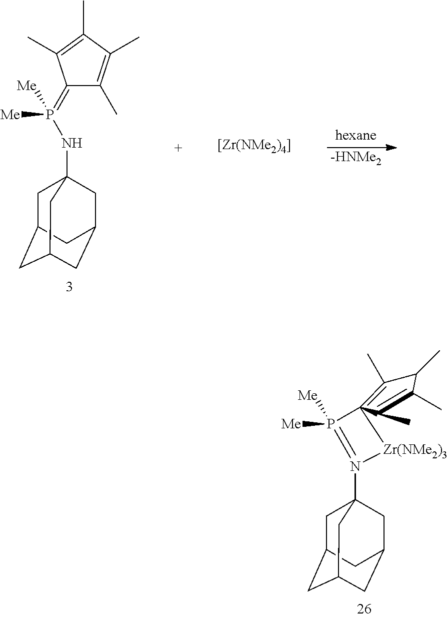

A solution of 720 mg [Zr(NMe₂)₄] (2.69 mmol, 1.00 eq) in 50 mL hexane was cooled to −78° C. and 741 mg C₅Me₄PMe₂NHAd (2.69 mmol, 1.00 eq) was added portionwise in solid form. It was was warmed to RT for 12 to 16 hours, whereby a white precipitate had been formed. It was completely concentrated and recrystallized from hexane at −30° C. The white solid is difficult to dissolve in hexane, but soluble in toluene and benzene.

Yield: 1.03 g (69%).

CHN: C₂₅H₅₀N₄PZr MW: 528.89 g/mol

| | | found | found |
|---|---|---|---|
| | calculated | (1^{st} measurement) | (2^{nd} measurement) |
| C | 58.54 | 50.22 | 50.51 |
| H | 9.28 | 7.99 | 7.93 |
| N | 10.11 | 7.45 | 7.63 |

¹H-NMR (300.1 MHz, C₆D₆): δ=1.29 (d, ²J_{HP}=11.7 Hz, 6H, PMe₂), 1.62 (br, m, 6H, CH_{2Ad}), 1.79 (br, m, 6H, N—C(CH₂)₃), 2.00 (s, 3H, CH_{Ad}), 2.18 (br, m, 6H, C₅Me₄), 2.32 (br, m, 6H, C₅Me₄), 3.04 (s, 18H, NMe₂) ppm.

¹³C-NMR (75.5 MHz, C₆D₆): δ=12.1 (s, C₅Me₄), 15.3 (s, C₅Me₄), 21.9 (d, ¹J_{CP}=48.6 Hz, PMe₂), 30.7 (s, CH_{Ad}), 36.8 (s, CH_{2Ad}), 45.1 (s, Zr—NMe₂), 46.3 (d, ³J_{CP}=8.5 Hz, NC(CH₂)₃), 55.5 (d, ²J_{CP}=6.0 Hz, P═N—C_{Ad}), 84.4 (s, ipso-C_{Cp}) 120.9 (d, ^{2,3}J_{CP}=9.4 Hz, C(Me)═C(Me)), 126.4 (d, ^{2,3}J_{CP}=12.8 Hz, C(Me)═C(Me)) ppm.

³¹P-NMR (81.0 MHz, C₆D₆): δ=13.3 ppm.

EI/MS (70 eV): m/z (%)=332 (3.6) [ligand⁺], 269 (2.8), 227 (42.6), 211 (19.0) [Me₂PNAd⁺], 196 (18.8) [MePNAd⁺], 170 (100.0), 150 (65.7) [AdN⁺], 136 (14.9) [Ad⁺].

IR (Nujol): 2854 [v (N—C)] (s), 2761 (w), 1399 [v (P═N)] (m), 1294 (w), 1282 (w), 1282 (w), 1034 (s), 902 (w), 777 [v (P—C)] (m), 679 (w), 646 (m), 534 (m), 482 [v (Zr—N)] (m) cm⁻¹.

Crystal Structure Analysis

Crystal data

| Identification code | eq85 |
|---|---|
| Habitus, color | prismatic, colourless |
| Crystal size | 0.42 × 0.42 × 0.18 mm³ |
| Crystal system | monoclinic |
| Space group | P 21/nZ = 4 |
| Unit cell dimensions | a = 10.069(2) Å α = 90°. |
| | b = 28.431(9) Å β = 100.32(3)°. |
| | c = 10.149(2) Å γ = 90°. |
| Volume | 2858.3(13) Å³ |
| Cell determination | 0 peaks with theta 0 to 0°. |
| Empirical formula | C27H51N4PZr |
| Formula mass | 553.91 |
| Density (calculated) | 1.287 Mg/m³ |
| Absorption coefficient | 0.462 mm⁻¹ |
| F(000) | 1184 |

Data collection

| | |
|---|---|
| Diffractometer type | IPDS1 |
| Wavelength | 0.71073 Å |
| Temperature | 293(2) K |
| Theta-range for data collection | 2.16 to 26.02°. |
| Index ranges | −12 <= h <= 12, −34 <= k <= 35, |
| | −12 <= l <= 12 |
| Data collection software | STOE Expose |
| Cell refinement software | STOE Cell |
| Data reduction software | STOE Integrate |

Resolution and refinement

| | |
|---|---|
| Reflections collected | 22397 |
| Independent reflections | 5577 [R(int) = 0.0313] |
| Completeness to theta = 25.00° | 99.9% |
| Observed reflections | 4558[I > 2sigma(I)] |
| Reflections used for refinement | 5577 |
| Absorption correction | semi-empirical |
| Max. and min. transmission | 0.8906 and 0.8229 |
| Largest difference peak and hole | 0.426 and −0.277 e, Å⁻³ |
| Solution | direct/difmap |
| Refinement | Least-squares on F² method |
| Treatment of H atoms | mixed |
| Programs used | SHELXS-86 (Sheldrick, 1986) |
| | SHELXL-97 (Sheldrick, 1997) |
| | Diamond 2, 1, STOE IPDS1 software |
| Data/restrictions/parameters | 5577/0/301 |
| Goodness-of-fit-on F² | 0.995 |
| R index (all data) | wR2 = 0.0707 |
| R index conventional | R1 = 0.0259 |
| [I > 2sigma(I)] | |

### Embodiment 23

### Synthesis of [(η⁵:η¹-Cp™ PPh₂NDip)Zr(NMe₂)₃]

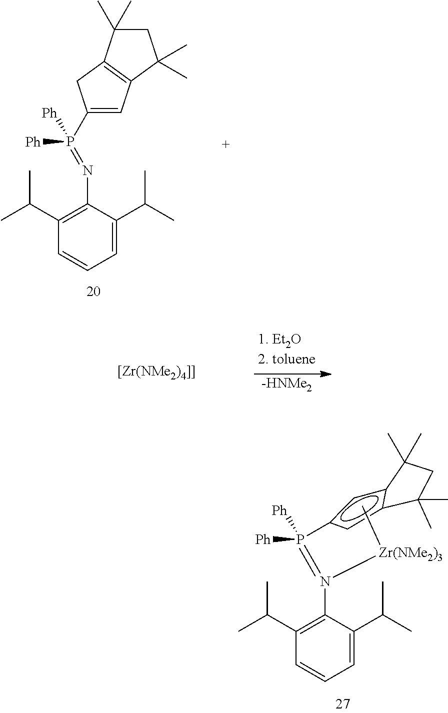

A solution of 256 mg [Zr(NMe₂)₄] (0.96 mmol, 1.00 eq) in 20 mL Et₂O was cooled to −78° C. and 500 mg CpH™ PPh₂NDip (0.96 mmol, 1.00 eq) was added portionwise in solid form. It was was warmed to RT for 12 to 16 hours, whereby the colorless solvent took a pale green color. It was reduced to dryness and the pale green remainder dissolved in 20 mL THF. The solvent was heated to 50° C. for 3 days.

³¹P-NMR (81.0 MHz, 1. Et₂O, 2. THF): δ=1. after stirring during 12 to 16 hours in Et₂O: 2.3 (35%), −14.8 (65%) [ligand] ppm; 2. after stirring for 3 d in THF at 50° C.: five signals, main signal at −14.5 (49%) [ligand] ppm.

### Embodiment 24

### Synthesis of [(η⁵:η¹-Cp™ PPh₂NAd)Zr(NMe₂)₃]

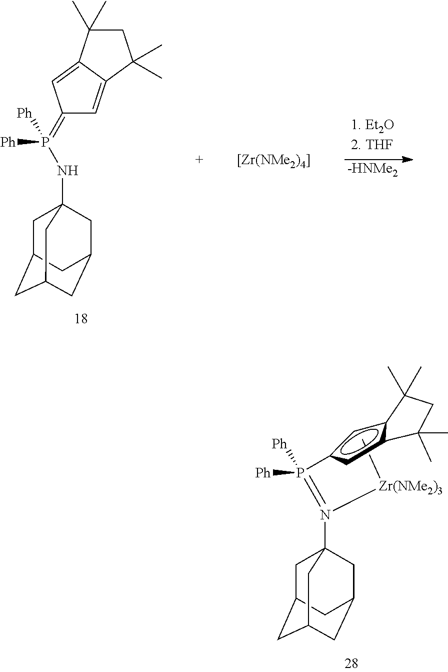

A solution of 270 mg [Zr(NMe₂)₄] (1.01 mmol, 1.00 eq) in 20 mL Et₂O was cooled to −78° C. and 500 mg Cp™ PPh₂NHAd (1.01 mmol, 1.00 eq) was added portionwise in solid form. It was warmed to RT during 12 to 16 hours, whereby a grey precipitate precipitated from the black solvent. It was reduced to dryness and the dark grey remainder was dissolved in 20 mL THF. The solvent was heated to 50° C. for 3 days.

³¹P-NMR (81.0 MHz, 1. Et₂O, 2. C₆D₆): δ=1. after stirring for 12 to 16 hours in Et₂O: 16.7 (100%) [ligand] ppm; 2. after stirring for 3 d in THF at 50° C.: 16.7 (100%) [ligand] ppm.

### Embodiment 25

### In situ synthesis of [(η⁵:η¹-C₅H₄PPh₂NDip)Zr(CH₂SiMe₃)₃]

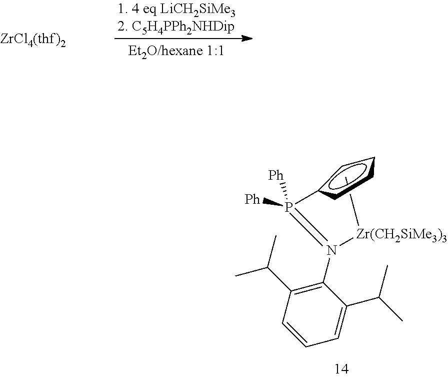

377 mg (1.00 mmol, 1.00 eq) LiCH₂SiMe₃ was added in solid form at 0° C. to a suspension of 377 mg ZrCl₄(thf)₂ (1.00 mmol, 1.00 eq) in 10 mL hexane/Et₂O=1:1 and kept at 0° C. under stirring for 2 h. Thereby, a white precipitate was formed. Subsequently, 426 mg C₅H₄PPh₂NHDip (1.00 mmol, 1.00 eq) was added in solid form at 0° C. and the reaction mixture was warmed to RT during 12 to 16 hours. Thereby, the suspension color changed from yellow into grey-green. It was reduced to half of the initial volume, filtered over Celite and the white remainder washed with 10 mL hexane. The filtrate was reduced to dryness. Thereby, a orange-colored oil was obtained. By recrystallization from hexane at −80° C. 252 mg of a white solid was obtained (yield 32%).

¹H-NMR (300.1 MHz, C₆D₆): δ=0.20 (s, 27H, Si(CH₃)₃), 0.89 (s, 6H, Zr—CH₂—Si), 1.11 (d, ³J_{HH}=7.0 Hz, 12H, Me₂CH), 3.69 (sept, 2H, ³J_{HH}=7.4 Hz, Me₂CH), 6.43 (m, 2H, H_{Cp}), 6.65 (m, 2H, H_{Cp}), 6.99 (m, 6H, m-/p-Ph), 7.03 (m, 2H, m-Dip), 7.13 (m, 1H, p-Dip), 7.42-7.49 (m, 4H, o-Ph) ppm.

³¹P-NMR (81.0 MHz, C₆D₆): δ=−10.9 ppm.

### Embodiment 26

### Synthesis of [η⁵:η¹-C₆H₄PPh₂NDip]Y(CH₂SiMe₃)₂(thf)

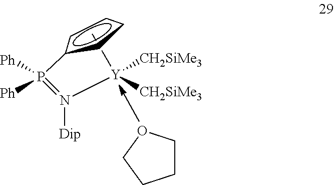

To a suspension of YCl₃(thf)₃ (411 mg, 1.00 mmol), THF (0.3 mL, 3.7 mmol) and [η⁵:η¹-C₅H₄PPh₂NHDip] (425 mg, 1.00 mmol) in diethyl ether (30 mL), a solution of LiCH₂SiMe₃ (286 mg, 3.04 mmol) in hexane (15 mL) was added dropwise at 0° C. After completed addition of LiCH₂SiMe₃ the solution was stirred for another 1.5 h at 0° C. Subsequently, the LiCl formed during the reaction was filtered off. The solvent was drawn off and the remainder extracted with hexane. Crystallization at −30° C. resulted in a white microcrystalline solid. Yield: 34% (231 mg).

¹H-NMR (300.1 MHz, C₆D₆): δ=−0.48 (br. s, 4H, CH₂TMS), 0.46 (s, 18H, CH₂TMS), 0.74 (br. s, 12H, Me₂CH), 1.14 (m, 4H, THF), 3.18 (sept, ³J_{HH}=6.8 Hz, 2H, Me₂CH), 3.66 (m, 4H, THF), 6.74 (m, 2H, Cp), 6.90-7.00 (m, 9H, Ar), 7.09 (m, 2H, Cp), 7.47 (m, 4H, o-Ph) ppm.

¹³C{¹H} NMR (75.5 MHz, C₆D₆): δ=4.6 (TMSCH₂), 24.5 (br, s, Me₂CH), 24.9 (THF), 29.0 (CHMe₂), 31.6, 32.1 (CH₂TMS), 70.1 (THF), 94.5 (d, J=125 Hz, ipso-Cp), 115.5 (d, J=13.5 Hz, Cp), 119.0 (d, J=14.4 Hz, Cp), 124.2 (d, J=4.0 Hz, p-Dip), 124.4 (d, J=3.5 Hz, m-Dip), 128.4(d, J=12 Hz, m-Ph), 129.5 (d, J=88 Hz, ipso-Ph), 132.3 (d, J=2.9 Hz, p-Ph), 133.1 (d, J=9.6 Hz, o-Ph), 141.4 (d, J=9.8 Hz, ipso-Dip), 145.2 (d, J=6.4 Hz, o-Dip), 188.1 ppm.

³¹P{¹H} NMR (81.0 MHz, C₆D₆): δ=9.6 (s) ppm.

Elementary analysis: Calculated for C₄₁H₅₉NOPSi₂Y (757.99): C 64.97, H 7.85, N 1.85. Found: C 64.56, H 7.80, N 1.90.

### Embodiment 27

### Synthesis of [(η⁵:η¹-C₅Me₄PMe₂NAd]Y(CH₂SiMe₃)₂

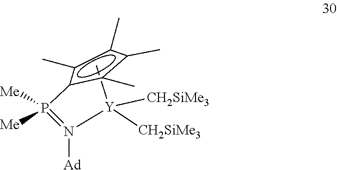

The production takes place analogously to the procedure described in embodiment 1.

To a suspension of YCl₃(dme)₂ (275 mg, 1.00 mmol) and [η⁵:η¹-C₅Me₄PMe₂NHAd] (330 mg, 1.00 mmol) in diethyl ether (20 mL), a solution of LiCH₂SiMe₃ (290 mg, 3.08 mmol) in hexane (20 mL) was added dropwise at 0° C. After completed addition of LiCH₂SiMe₃ the solution was stirred for another 1.5 h at 0° C. Subsequently, the LiCl formed during the reaction was filtered off. The solvent was drawn off and the remainder extracted with hexane. Crystallization at −30° C. resulted in a white microcrystalline solid. Yield: 58% (343 mg).

¹H (300.1 MHz, C₆D₆) −0.70, −0.75 (2*dd, 2*2H, ²J_{HY}=3.0 Hz, ²J_{HH}=11 Hz, ABX system), 0.40 (s, 18H, 2*SiMe₃), 1.13 (d, 6H, ²J_{HP}=12.5 Hz, Me₂P), 1.56 (m, 6H, Ad), 1.71 (m, 6H, Ad), 2.00 (m, 3H, Ad), 2.03 (s, 6H, Me₄C₅), 2.12 (s, 6H, Me₄C₅).

¹³C{¹H} (75.5 MHz, C₆D₆) δ=4.7 (s, SiMe₃), 11.4 (s, Me-C═C-Me), 13.9 C═C-Me), 21.9 (d, ¹J_{CP}=55 Hz, Me₂P), 30.2 (s, HC(CH₂)₃), 31.4 (d, ¹J_{CY}=34 Hz,

Y—CH₂Si) 36.3 (s, CH₂(CH)₂), 47.6 (d, ²J_{CP}=9.1 Hz, NC(CH₂)₃), 54.2 (s, ¹J_{CP}=7.5 Hz, N—C_{Ad}), 84.6 (d, ¹J_{CP}=116 Hz, Me₂P—Cᵢₚₛₒ), 121.8 (d, J_{CP}=13 Hz, Me₂C—CMe₂), 123.7 (d, J_{CP}=16 Hz, Me₂C—CMe₂) ppm.

³¹P{¹H} NMR (81.0 MHz, C₆D₆): δ=14.7 ppm.

Elementary analysis: Calculated for C₂₉H₅₅NPSi₂Y (593.82): C 58.66, H 9.34, N 2.36. Found: C 59.21, H 9.71, N 2.41.

### Embodiment 28

### Synthesis of [η⁵:η¹-C₆Me₄PMe₂NAd]Sc(CH₂SiMe₃)₂]

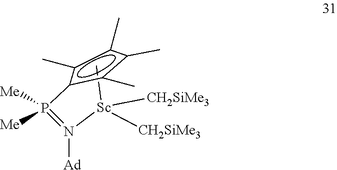

The production takes place analogously to the procedure described in embodiment 1.

To a suspension of ScCl₃(thf)₃ (367 mg, 1.00 mmol) and [η⁵:η¹-C₅Me₄PMe₂NHAd] (330 mg, 1.00 mmol) in diethyl ether (20 mL), a solution of LiCH₂SiMe₃ (290 mg, 3.08 mmol) in hexane (20 mL) was added dropwise at 0° C. After completed addition of LiCH₂SiMe₃ the solution was stirred for another 1.5 h at 0° C. Subsequently, the LiCl formed during the reaction was filtered off. The solvent was drawn off and the remainder extracted with hexane. Crystallization at −30° C. resulted in a white microcrystalline solid. Yield: 42% (231 mg).

¹H NMR (300.1 MHz, C₆D₆): δ=−0.40 (d, AB-system, ²J_{HH}=11.2 Hz, 2H, CH₂SiMe₃), −0.37 (d, AB-System, ²J_{HH}=11.2 Hz, 2H, CH₂SiMe₃), 0.36 (s, 18H, 3*CH₂SiMe₃), 1.17 (d, ²J_{HP}=12.5 Hz), 1.60 (m, 6H, NC(CH₂)₃), 1.83 (m, 6H, CH₂(CH)₂), 2.01 (s, 6H, C₅Me₄), 2.02 (m, 3H, CH(CH₂)₃), 2.14 (s, C₅Me₄) ppm.

¹³C{¹H} NMR (75.5 MHz, C₆D₆): δ=4.5 (s, SiMe₃), 12.0 (d, J=6.9 Hz, C₅Me₄), 14.4 (C₅Me₄), 21.6 (d, ²J_{CP}=55 Hz, Me₂P), 30.4 (CH(CH₂)₃), 36.5 (CH₂(CH)₂), 47.2 (d, J=8.7 Hz, NC(CH₂)₃), 54.6 (d, J=6.8 Hz NC), 84.8 (d, ¹J_{CP}=114 Hz, ipso-C₅Me₄), 122.5 (d, J=13.3 Hz, C₅Me₄), 125.7 (d, J=14.4 Hz, C₅Me₄) ppm.

³¹P{¹H} NMR (81.0 MHz, C₆D₆): δ=12.0 (s) ppm

Elementary analysis: Calculated for C₂₉H₅₅NPScSi₂ (549.87): C 63.35, H 10.08, N 2.55. Found: C 62.92, H 9.78, N 2.41.

### Embodiment 29

### Synthesis of [η⁵:η¹-C₅H₄PPh₂NDip]Sc(CH₂SiMe₃)₂

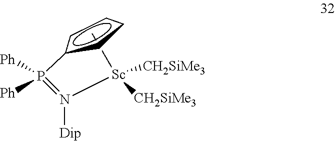

The production takes place analogously to the procedure described in embodiment 1.

To a suspension of ScCl₃(thf)₃ (367 mg, 1.00 mmol) and [η⁵:η¹-C₅H₄P Ph₂NHDip] (425 mg, 1.00 mmol) in diethyl ether (20 mL), a solution of LiCH₂SiMe₃ (290 mg, 3.08 mmol) in hexane (20 mL) was added dropwise at 0° C. After completed addition of LiCH₂SiMe₃ the solution was stirred for another 1.5 h at 0° C. Subsequently, the LiCl formed during the reaction was filtered off. The solvent was drawn off and the remainder extracted with hexane. Crystallization at −30° C. resulted in a white microcrystalline solid. Yield: 32% (206 mg).

¹H NMR (300.1 MHz, C₆D₆): δ=0.12 (br, s, 2H, CH₂SiMe₃), 0.25 (br, s, 2H, CH₂SiMe₃), 0.37 (s, 18H, CH₂SiMe₃), 1.25 (br, s, 12H, Me₂CH), 3.42 (sept, ³J_{HH}=6.8 Hz, 2H, Me₂CH), 6.77 (m, 2H, C₅H₄), 8.85-7.09 (m, 11H, C₅H₄, Ph, Dip), 7.41 (m, 4H, o-Ph) ppm.

¹³C{¹H} NMR (75.5 MHz, C₆D₆): δ=3.9 (s, CH₂SiMe₃), 23.5 (br, s, Me₂CH), 26.3 (br, s, Me₂CH), 28.8 (s, Me₂CH), 42.2 (br, s, CH₂TMS), 92.7 (d, J=121 Hz, ipso-C₅H₄), 118.3 (d, J=12.9 Hz, C₅H₄), 119.2 (d, J=14.2 Hz, C₅H₄), 124.8 (d, J=3.4 Hz, m-Dip), 125.3 (d, J=3.9 Hz, p-Dip), 127.7 (d, J=90 Hz, ipso-Ph) 128.7 (d, J=12.3 Hz, m-Ph), 132.8 (d, J=2.8 Hz, p-Ph), 133.5 (d, J=9.9 Hz, o-Ph), 139.9 (d, J=9.3 Hz, ipso-Dip), 145.8 (d, J=6.1 Hz, o-Dip) ppm.

³¹P{¹H} NMR (81.0 MHz, C₆D₆): δ=12.1 (s) ppm

Elementary analysis: Calculated for C₃₇H₅₃NPScSi₂ (643.94): C 69.01, H 8.30, N 2.17. Found: C 68.71, H 8.59, N 2.10.

### Embodiment 30

### Synthesis of [η⁵:η¹-C₅H₄PMe₂NDip]Nd(CH₂SiMe₃)₂(thf)

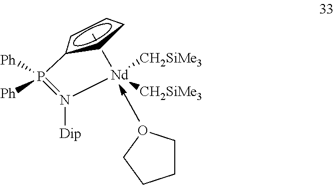

To a mixture of NdBr₃(thf)₄ (672.3 mg, 1.00 mmol) and [η⁵:η¹-C₅H₄PMe₂NHDip] (331 mg) in diethyl ether (15 mL), a solution of LiCH₂SiMe₃ (290 mg, 3.08 mmol) in toluene (15 mL) was added dropwise within 15 min at 0° C. After completed addition of LiCH₂SiMe₃ the solution was stirred for another 15 min and subsequently reduced to ⅓ of its original volume. The obtained precipitate is removed by filtration over Celite. The transparent green solution is left standing at −30° C. to crystallize. Subsequently, 15 mL hexane was added and the formed blue precipitate was filtered off.

Yield: 7.6% (55 mg, 0.076 mmol). The green substance is strongly paramagnetic; the characterization took place by means of monocrystal XRD.

Elementary analysis: Calculated for C₃₁H₅₇NNdOPSi₂ (691.19): C 53.87, H 8.31, N 2.03. Found: C 51.10, H 10.23, N 1.70.

### Embodiment 31

### Synthesis of [η⁵:η¹-C₅Me₄PMe₂NAd]Nd(CH₂SiMe₃)₂

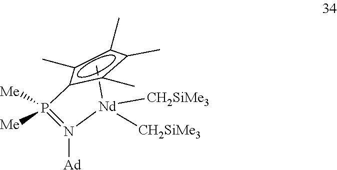

The production takes place analogously to the procedure described in embodiment 5.

To a mixture NdCl₃(dme) (340 mg, 1.00 mmol) and [η⁵:η¹-C₅Me₄PMe₂NHAd] (340 mg, 1.03 mmol) in diethyl ether (15 mL), a solution of LiCH₂SiMe₃ (290 mg, 3.08 mmol) in toluene (15 mL) was added dropwise within 15 min at 0° C. After completed addition of LiCH₂SiMe3 the solution was stirred for another 15 min and subsequently reduced to ⅓ of its original volume. The obtained precipitate is removed by filtration over Celite. The transparent green solution is left standing at −30° C. to crystallize. Subsequently, 15 mL hexane was added and the formed microcrystalline blue precipitate was filtered off. Yield: 49% (315 mg, 0.49 mmol).

¹H NMR (300.1 MHz, C₆D₆): δ=−21.72 (s, 6H, Me₄C₅), −13.52 (s, 6H, Me₄C₅), −5.83 (d, ²J_{HH}=10 Hz, 3H, HCH(CH)₂), −4.94 (s, 3H, CH(CH₂)₂), −3.62 (d, ²J_{HH}=10 Hz, 3H, HCH(CH)₂), 2.62 (s, 18H, SiMe₃), 10.58 (d, ²J_{HP}=13 Hz, 6H, Me₂P), 11.45 (s, 6H, CH₂CN), 20.22 (br, s, 2H CH₂Si), 29.45 (br, s, 2H CH₂Si) ppm.

Elementary analysis: Calculated for C₂₉H₅₅NNdPSi₂ (649.15): C 53.66, H 8.54, N 2.16. Found: C 51.70, H 7.90, N 1.82.

### Embodiment 32

### Intramolecular Hydroamination of ω-Aminoalkenes with CG-CpPN Complexes of Zirconium

Some of the CG-CpPN complexes of the zirconium, according to the present invention, were used as catalysts for the intramolecular hydroamination of ω-alkenes. 2,2-diphenyl-pent-4-amine was used as a substrate:

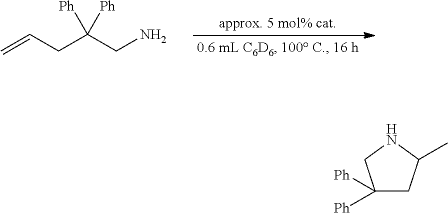

The catalysis experiments are hereinafter represented in the form of a table:

| | | | | | TOF/ |
|---|---|---|---|---|---|
| | | Mol % | Amount | Amount | h⁻¹ |
| yield/% | Catalyst used | cat. | cat./mg | amine/mg | (min. value) |
| 86¹⁾ | 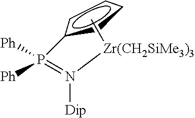 | 4.7 | 14.17 | 93 | 1.1 |
| 100 | 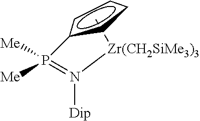 | 5.3 | 13.51 | 93 | 1.2 |
| 100 | 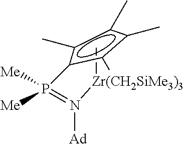 | 4.6 | 13.39 | 93 | 1.4 |
| 67²⁾ | 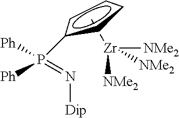 | 4.5 | 11.51 | 93 | 0.9 |
| 100 | 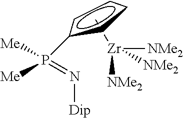 | 5.3 | 11.07 | 93 | 1.2 |
| 100 | 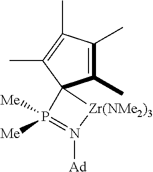 | 4.5 | 9.82 | 93 | 1.4 |

(¹⁾= reaction monitoring after 20 h did not show any further reaction, ²⁾= reaction monitoring after 20 h did show further reaction; i.e. the catalyst system was still active after 16 h).

The examinations show that neutral CG complexes of zirconium together with the CpPN ligands are active in the intramolecular hydroamination of 2,2-diphenyl-pent-4-en-1-amine.

### Embodiment 33

### Intramolecular Hydroamination of ω-Aminoalkenes with CG-CpPN Complexes of Rare-Earth Metals

By way of example, catalysis studies concerning the intramolecular hydroamination of ω-aminoalkenes are listed. The reactions are carried out at 25° C. and monitored via ¹H-NMR-spectroscopy in C₆D₆ or by quantitative GC as well. 2,2-Diphenyl-pent-4-en-1-amine and 2,2-Diphenyl-pent-4-en-1-amine are used as standard substrates. The selectivity of the cyclisation is 100% with all catalysts used. This means that the indicated yields correspond to the respective conversions after the time t (first column):

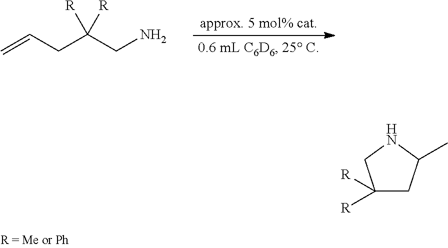

| | | | | | | TOF/ |
|---|---|---|---|---|---|---|
| | | | | Amount/ | Amount/ | h⁻¹ |
| | | Substrate | Mol % | cat. | amine | (min. |
| yield/% | Catalyst used | R= | cat. | mg | mg | value) |
| 92 (15) | 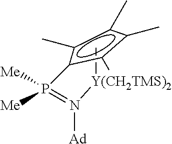 | Ph | 5.2 | 9.47 | 73 | 70.5 |
| 21 (15) | 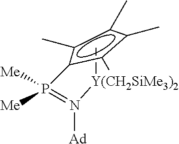 | Me | 5.0 | 7.46 | 28 | 15.2 |
| 33 (6) | 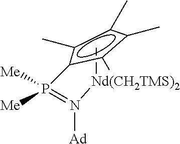 | Ph | 4.2 | 6.32 | 55 | 78.0 |
| 24 (17) | 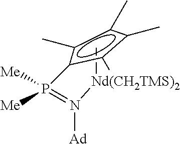 | Me | 4.9 | 9.29 | 33 | 17.9 |

The TOF values are in the range which is usual for hydroaminations with CG catalyst of the rare-earth metals with the classical CpSiN ligands [(C₅Me₄SiMe₂N^{t}Bu)Ln(R¹)(thf)] [Ref: T. J. Marks et al., Organometallics 1999, 18, 2568-2570].

Here, TOF stands for “turnover frequency”.

### Embodiment 34

### Generation of the Cationic Catalyst Species for the Polymerization of Ethane with the Help of tris-(pentafluorophenyl)-bor

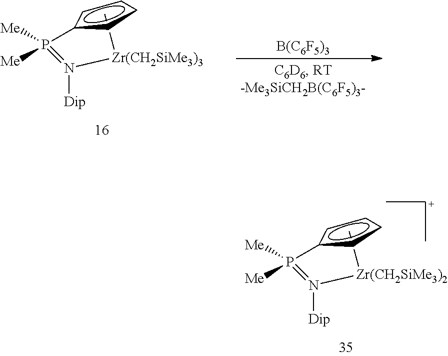

22.98 mg [(η⁵:η¹-C₅H₄PMe₂NDip)Zr(CH₂SiMe₃)₃] (35.18 μmol, 1.00 eq) and 23.5 mg B(C₆F₅)₃ (45.90 mmol, 1.95 eq) were weighed in an NMR tube and dissolved in 0.6 mL C₆D₆. The reaction mixture was shaken for 30 sec at RT. Hereby, two phases, immiscible with one another, were formed. The benzene phase was drawn off with the help of a syringe and the remaining, pale yellow ionic liquid was examined using NMR spectroscopy. The liquid is stable at RT for several days.

¹H-NMR (300.1 MHz, CD₂Cl₂): δ=0.26 (s, 9H, Si(CH₃)₃), 0.27 (s, 9H, Si(CH₃)₃), 0.30 (d, ⁴J_{BH}=12.5 Hz, 9H, BCH₂Si(CH₃)₃), 0.89 (br, s, 2H, BCH₂Si(CH₃)₃), 1.04 (d, ²J_{HH}=10.7 Hz, 2H, Zr—CH₂—Si), 1.42 (d, ³J_{HH}=6.9 Hz, 12H, Me₂CH), 1.44 (d, ²J_{HH}=11.1 Hz, 2H, Zr—CH₂—Si), 1.97 (d, ²J_{HP}=12.3 Hz, PMe₂), 2.78 (sept, 2H, ³J_{HH}=6.6 Hz, Me₂CH), 7.08 (br, m, 2H, H_{Cp}), 7.27 (br, m, 2H, H_{Cp}), 7.40 (d, ³J_{HH}=7.8 Hz, 2H, m-Dip), 7.50 (br, m, 1H, p-Dip) ppm.

¹³C-NMR (75.5 MHz, CD₂Cl₂): δ=1.3 (s, Si(CH₃)₃), 2.2 (s, Si(CH₃)₃), 3.2 (s, BCH₂Si(CH₃)₃), 13.2 (d, ¹ J_{CP}=59.1 Hz, PMe₂), 24.8 (s, BCH₂Si(CH₃)₃), 26.3 (Me₂CH), 26.4 (Me₂CH), 28.7 (s, Me₂CH), 80.3 (s, Zr—CH₂—Si), 81.4 (s, Zr—CH₂—Si), 117.7 (d, ^{2,3}J_{CP}=13.6 Hz, C_{Cp}), 117.9 (d, ^{2,3}J_{CP}=13.1 Hz, C_{Cp}), 118.8 (d, ^{2,3}J_{CP}=12.8 Hz, C_{Cp}), 119.1 (d, ^{2,3}J_{CP}=13.6 Hz, C_{Cp}), 126.7 (s, p-Dip), 129.1 (d, ⁴J_{CP}=3.6 Hz, m-Dip), 145.6 (d, ³J_{CP}=6.4 Hz, o-Dip) ppm.

The signals of the carbon atoms of the perfluorinated aryl ring cannot be observed in the ¹³C-NMR spectrum.

³¹P-NMR (81.0 MHz, CD₂Cl₂): δ=27.4 ppm.

¹⁹F-NMR (188.3 MHz, CD₂Cl₂): δ=−135.4 (d, ³J_{FF}=24.5 Hz), −167.5 (t, ³J_{FF}=20.7 Hz), −170.1 (t, ³J_{FF}=21.2 Hz) ppm.

### Embodiment 35

### Generation of the Cationic Catalyst Species for the Polymerization of Ethane with the help of N,N-dimethylanilinium-tetrakis-pentafluorphenyl-borate

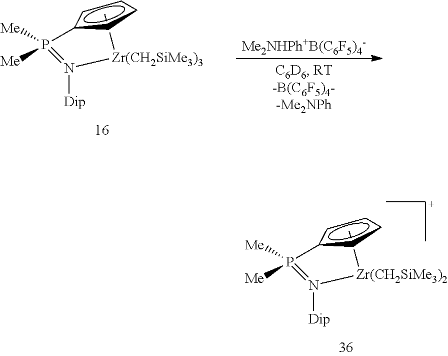

29.39 mg [(η⁵:η¹-C₅H₄PMe₂NDip)Zr(CH₂SiMe₃)₃] (44.99 μmol, 1.00 eq) and 37.76 mg Me₂NHPh⁺B(C₆F₅)₄⁻ (47.13 mmol, 1.05 eq) were weighed in an NMR tube and dissolved in 0.6 mL C₆D₆. The reaction mixture was shaken for 30 sec at RT. Hereby, two phases, immiscible with one another, were formed. The benzene phase was drawn off with the help of a syringe and the remaining, yellow-green ionic liquid was examined using NMR spectroscopy. The liquid is stable at RT for several days.

¹H-NMR (300.1 MHz, CD₂Cl₂): δ=0.18 (s, 18H, Si(CH₃)₃), 0.98 (s, 2H, Zr—CH₂—Si), 1.35 (d, ³J_{HH}=6.6 Hz, 12H, Me₂CH), 1.36 (d, ²J_{HH}=10.7 Hz, 2H, Zr—CH₂—Si), 2.00 (d, ²J_{HP}=12.6 Hz, PMe₂), 2.73 (sept, 2H, ³J_{HH}=6.9 Hz, Me₂CH), 7.06 (m, br, 2H, H_{Cp}), 7.25 (m, br, 2H, H_{Cp}), 7.35 (d, ³J_{HH}=7.8 Hz, 2H, m-Dip), 7.43 (m, br, 1H, p-Dip) ppm.

¹³C-NMR (75.5 MHz, CD₂Cl₂): δ=2.3 (s, Si(CH₃)₃), 13.6 (d, ¹J_{CP}=59.1 Hz, PMe₂), 25.1 (Me₂CH), 26.5 (Me₂CH), 29.0 (s, Me₂CH), 80.2 (s, Zr—CH₂—Si), 117.7 (d, ^{2,3}J_{CP}=13.0 Hz, C_{Cp}), 118.9 (d, ^{2,3}J_{CP}=13.4 Hz, C_{Cp}), 128.6 (s, ⁵J_{CP}=3.0 Hz, m-Dip), 128.9 (d, ⁴J_{CP}=3.4 Hz, p-Dip), 145.5 (d, ³J_{CP}=5.2 Hz, o-Dip) ppm.

The signals of the carbon atoms of the perfluorinated aryl ring cannot be observed in the ¹³C-NMR spectrum.

³¹P-NMR (81.0 MHz, CD₂Cl₂): δ=27.4 ppm.

¹⁹F-NMR (188.3 MHz, CD₂Cl₂): δ=−135.5 (s, br), −166.0 (s, br), −169.9 (t, ³J_{FF}=20.7 Hz) ppm.

### Embodiment 36

### Polymerization of Ethene

The polymerization of ethene was carried out in a 250 mL Two-neck Schlenk flask at a temperature of 50° C. and a pressure of 1 atm. The ethene was freed from oxygen via a column over a Cu catalyst (R3-11G-Kat., BASF) and subsequently via a second column with molecular sieve 3 Å from traces of water. The reaction vessel was flushed with a solution of triisobutylaluminum (TIBA) in 145 mL at RT to remove traces of possibly absorbed water. Due to its function as scavenger, the triisobutylaluminum remained in the reaction vessel during the polymerization. Ethene was passed through the solution during approx. 20 min to generate a saturated solution. Using glove box, approx. 50 μmol (1.0 eq) of the catalyst was dissolved in 5 mL toluene and activated by reaction with approx. 75 μmol (1.5 eq) B(C₆F₅)₃ (BCF). Subsequently, the active catalyst species was added all at once to the toluene solution of TIBA saturated with ethene and heated to 50° C. With all tested catalysts, heat generation occurred immediately after addition of the cationic species. The solution became instantly more viscous and after a few minutes polyethene precipitated in the form of a white solid. The reaction was stopped after 30 min by addition of 20 mL of a 5% solution of HCl in ethanol. The content of the reaction vessel was added to 200 mL of a 5% solution of HCl in ethanol. The formed polyethylene was filtered off after 2 h, washed with ethanol and dried in the drying cabinet at 100° C.

Since the activity of a catalyst depends very strongly on the reaction conditions, Eurocene 5031 [Zr^{IV}(nBuCp)₂Cl₂], which is active in polymerization catalysis, was used under similar conditions for an appropriate comparison. For this purpose, 25 mmol MAO in 245 mL toluene was provided and flushed with ethane for 20 min. Using the glove box, 50 μmol of the catalyst was dissolved in 5 mL toluene and added all at once to the toluene solution of methylaluminoxane (MAO) saturated with ethene. The reaction was stopped after 30 min by addition of 20 mL of a 5% solution of HCl in ethanol. The content of the reaction vessel was added to 200 mL of a 5% solution of HCl in ethanol. The formed polyethylene was filtered off after 2 h, washed with ethanol and dried in the drying cabinet at 100° C.

Tested Catalysts

[Zr^{IV}(nBuCp)₂Cl₂]
37

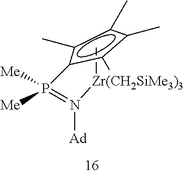

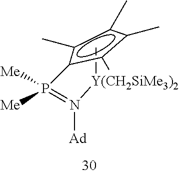

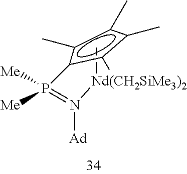

| | | scavenger | | | | melting |
|---|---|---|---|---|---|---|
| pre-catalyst | co-catalyst | (TIBA) | T/° C. | t/min | yield/g | point/° C. |
| 37 | MAO | / | 25 | 30 | 12.48 | 138 |
| 20.23 mg | 1.45 g | | | | | |
| 16 | BCF | 340 mg | 50 | 30 | 10.54 | 134 |
| 32.72 mg | 54.38 mg | | | | | |
| 30 | BCF | 340 mg | 50 | 30 | 8.21 | 132 |
| 27.84 mg | 49.29 mg | | | | | |
| 34 | BCF | 340 mg | 50 | 30 | 6.78 | 136 |
| 30.63 mg | 54.46 mg | | | | | |

BCF = tris(pentafluorophenyl)borane and
MAO = methylaluminoxane.

1. Cyclopentadienylphosphazene complexes (CpPN Complexes) of metals of the third and fourth group and of the lanthanoids, wherein
the metal is selected from the group Sc, Y, La, Ti, Zr, Hf, Ce, Pr, Nd, Pm, Sm, Eu, Gd, Tb, Dy, Ho, Er, Tm, Yb, in which the metal atom
is in the oxidation state +III, if it is a metal of the third group or a lanthanoid, or
is in oxidation stage +IV if it is a metal of the fourth group, and
exactly one cyclopentadienylphosphazene unit is present in the complex, and
the cyclopentadienylphosphazene unit is bound as a monoanionic ligand to the metal atom and
the metal atom is also bound to further anionic ligands which do not belong to the cyclopentadienylphosphazene unit.

2. Cyclopentadienylphosphazene complexes (CpPN complexes) of the metals of the third and fourth group and the lanthanoids according to claim 1, wherein the monoanionic cyclopentadienylphosphazene is a structure according to formula 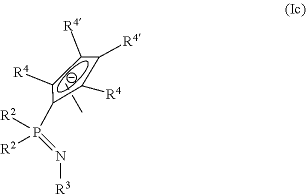
wherein
R²=a branched or unbranched alkyl group with 1 to 10 carbon atoms, or an aryl group,
R³=a branched or unbranched alkyl group with 1 to 10 carbon atoms, 1-adamantyl (Ad) or an aryl group, and
R⁴ and R^{4′}=H or methyl (Me) or
R⁴, R^{4′}, and the cyclopentadienyl ring together form a 4,4,6,6-tetramethyl-5,6-dihydropentalene-2(4H)-ylidene unit.

3. Cyclopentadienylphosphazene complexes (CpPN complexes) of the metals of the third and fourth group and the lanthanoids according to claim 2, wherein the monoanionic cyclopentadienylphosphazene is selected from

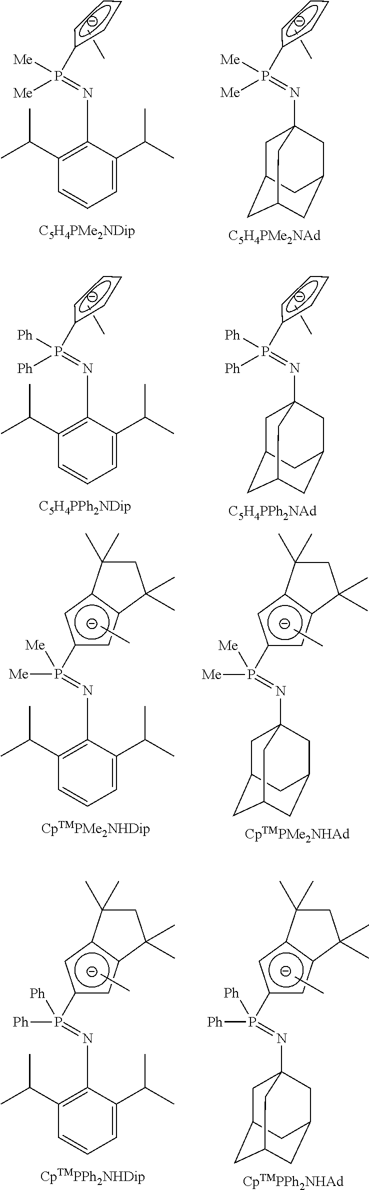

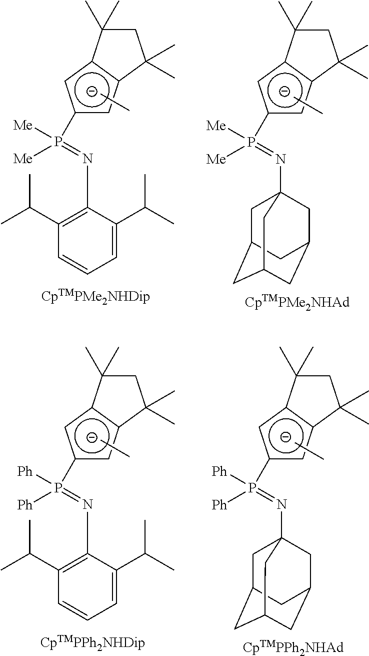

4. Cyclopentadienylphosphazene complexes (CpPN complexes) of the metals of the third and fourth group and the lanthanoids according to claim 1, wherein the complex is a structure according to formula (IV)
[(CpPN)MR¹ₘ(L)ₚ] (IV),
wherein
M=metal, selected from the group Sc, Y, La, Ti, Zr, Hf, Ce, Pr, Nd, Pm, Sm, Eu, Gd, Tb, Dy, Ho, Er, Tm, Yb
m=3 if the metal is of the fourth group and thus is in oxidation stage +IV,
m=2 if the metal is of the third group or a lanthanoid and thus is in oxidation stage +III,
p=0 or 1,
and
R¹ represent anionic ligands which independently of one another are selected from
fluoride, chloride, bromide, iodide, cyanide, cyanate, thiocyanate, azide,
-Me, —CH₂, CH₂CMe₂Ph, —CH₂CMe₃, —CH₂Ph, —CH₂SiMe₃,
—O-Aryl, —OSiMe₃, —OR⁵, —NR⁵₂
wherein
R⁵=a branched or unbranched alkyl group with 1 to 10 carbon atoms, or a phenyl group,
and
L represents a neutral ligand, selected from
an ether (for example THF, diethyl ether Et₂O, dimethoxyethane DME), a thioether, a tertiary amine, pyridine.
and R², R³, R⁴, und R^{4′} have the meanings indicated above.

5. Cyclopentadienylphosphazene complexes (CpPN complexes) of the metals of the third and fourth group and the lanthanoids according to claim 1, wherein the complex is a structure according to formula (V) 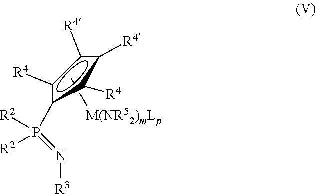
wherein m, p, R², R³, R⁴, R^{4′} und R⁵ and L have the meanings indicated above.

6. Cyclopentadienylphosphazene complexes (CpPN complexes) of the metals of the third and fourth group and the lanthanoids according to claim 1, wherein the complex is a structure according to formula (VI) 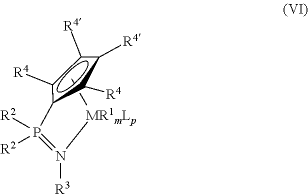
wherein m, p, R², R³, R⁴, R^{4′} and R⁵ and L have the meanings indicated above.

7. Cyclopentadienylphosphazene complexes (CpPN complexes) of the metals of the third and fourth group and the lanthanoids according to claim 1, wherein the complex is a structure according to formula (VII)
[(CpPN)MXₘ(thf)ₜ] (VII)
wherein
CpPN=cyclopentadienylphosphazene,
X=fluoride, chloride, bromide, iodide,
t=0, 1, or 2 if the metal is a metal of the fourth group,
t=0, 1, 2 or 3 if the metal is a metal of the third group or a lanthanoid, and M and m are as defined above.

8. Cyclopentadienylphosphazene complexes (CpPN complexes) of the metals of the third and fourth group and the lanthanoids according to claim 1, wherein the complex is a structure according to formula (VIII)
[(CpPN)MR⁶ₘ₋₁(L)]^{⊕}X^{⊖} (VIII),
wherein
M=metal, selected from the group Sc, Y, La, Ti, Zr, Hf, Ce, Pr, Nd, Pm, Sm, Eu, Gd, Tb, Dy, Ho, Er, Tm, Yb,
CpPN=cyclopentadienylphosphazene,
m=3 if the metal is of the fourth group and thus is in oxidation stage +IV,
m=2 if the metal is a metal of the third group or a lanthanoid and thus is in oxidation stage +III,
and
R⁶ represent anionic ligands which independently of one another are selected from
fluoride, chloride, bromide, iodide, cyanide, cyanate, thiocyanate, azide,
-Me, —CH₂, CH₂CMe₂Ph, —CH₂CMe₃, —CH₂Ph, —CH₂SiMe₃,
—O-Aryl, —OSiMe₃,
—OR⁵, —NR⁵₂,
wherein
R⁵=a branched or unbranched alkyl group with 1 to 10 carbon atoms, or a phenyl group,
and
L represents a neutral ligand, selected from
an ether (for example THF, diethyl ether Et₂O, dimethoxyethane DME), a thioether, a tertiary amine, pyridine,
and
X⁻ is selected from fluoroborate, tetraphenylborate, tetrakis-(3,5-trifluoromethylphenyI)-borate.

9. Cyclopentadienylphosphazene complexes (CpPN complexes) of the metals of the third and fourth group and the lanthanoids according to claim 1, wherein the metal atom is homoleptically coordinated in relation to those anionic ligands which do not represent a cyclopentadienylphosphazene unit.

10. Cyclopentadienylphosphazene complexes (CpPN complexes) of the metals of the third and fourth group and the lanthanoids according to claim 1, wherein the metal atom is homoleptically coordinated in relation to those anionic ligands which do not represent a cyclopentadienylphosphazene unit, wherein these anionic ligands are selected from the group —CH₂Ph, —CH₂SiMe₃ and NMe₂.

11. Method for the production of cyclopentadienylphosphazene complexes (CpPN complexes) of the metals of the third and fourth group and the lanthanoids according to claim 1, wherein the method is carried out in situ and comprise the steps:
a) reacting one equivalent of a metal halide MX_{q} with q equivalents of an alkali metal or alkaline earth metal salt of the ligand R¹ in an ether at a temperature below −70° C., wherein
X=F, Cl, Br, I and
q=3 if M is a metal of the third group or a lanthanoid,
q=4 if M is metal of the fourth group,
and R¹ is as defined above,
b) subsequently, one equivalent of a protonated cyclopentadienylphosphazene [CpPN]H is added.

12. Method for the production of cyclopentadienylphosphazene complexes (CpPN complexes) of the metals of the third and fourth group and the lanthanoids according to claim 10, wherein first one equivalent of the metal halide MX_{q} is reacted with one equivalent of the protonated ligand [CpPN]H and subsequently q equivalents of an alkali metal or alkaline earth metal salt of the ligand R¹ are added.

13. Method for the production of cyclopentadienylphosphazene complexes (CpPN complexes) of the metals of the third and fourth group and the lanthanoids according to claim 10, wherein one equivalent of an isolated compound MR⁷_{q} is reacted with one equivalent of the protonated ligand [CpPN]H in an ether or in an aliphatic tertiary amine at temperatures below
−70° C., wherein
R⁷ is selected from
-Me, —CH₂, CH₂CMe₂Ph, —CH₂CMe₃, —CH₂Ph, —CH₂SiMe₃,
—O-Aryl, —OSiMe₃,
—OR⁵, —NR⁵₂,
wherein
R⁵=a branched or unbranched alkyl group with 1 to 10 carbon atoms, or a phenyl group, and
q is as defined above.

14. Method for the production of CpPN complexes according to claim 7, wherein one equivalant of the anhydrous metal halide is reacted in an ether at a temperature below −70° C. with an alkali metal or alkaline earth-metal salt of the CpPN ligand.

15. Method for the production of cationic CpPN complexes according to claim 7, wherein the corresponding complex [(CpPN)MR⁶ₘ] is reacted with a cation-generating reagent.

16. Use of neutral CpPN complexes 1 to 6, 9 and 10 as catalysts for the polymerization of olefins.

17. Use of cationic CpPN complexes according to claim 7 as catalysts for the hydroamination of olefins.
